(19) United States
(12) Patent Application Publication
(10) Pub. No.: US 2022/0317385 A1
(43) Pub. Date: Oct. 6, 2022

(54) OPTICAL CONNECTOR CLEANING TOOL

(71) Applicant: Tomoegawa Co., Ltd., Tokyo (JP)

(72) Inventors: Masayoshi SUZUKI, Shizuoka-shi, Shizuoka (JP); Makoto GOTO, Shizuoka-shi, Shizuoka (JP)

(21) Appl. No.: 17/633,992

(22) PCT Filed: Aug. 7, 2020
(86) PCT No.: PCT/JP2020/030462

§ 371 Date: Feb. 9, 2022

(30) Foreign Application Priority Data
Aug. 14, 2019 (JP) 2019-148904
Sep. 20, 2019 (JP) 2019-171547
May 21, 2020 (JP) 2020-089088

(51) Int. Cl. G02B 6/38; B08B 1/00; B08B 7/00

(52) U.S. Cl. CPC G02B 6/3866; B08B 1/006; B08B 7/0028; B08B 2240/02

(57) ABSTRACT

Provided is an optical connector cleaning tool with a simple structure that can sufficiently transmit transmission force. The optical connector cleaning tool includes a supply reel on which a cleaning material is wound so that it can be fed out, a winding reel that winds the cleaning material that has passed through a cleaning head, an operating body that can be pivoted by operation by an operator, and a rotary engaging body that engages with the operating body to transmit the movement of the operating body to rotate the winding reel, in which the arc caused by the pivoting of the operating body is inscribed in the arc caused by the rotation of the rotary engaging body, and the operating body and the rotary engaging body are engaged.

### TECHNICAL FIELD

The present invention relates to an optical connector cleaning tool to clean the end face of the ferrule of an optical connector.

### BACKGROUND ART

As an optical connector cleaning tool to clean the optical connector, one that moves a cleaning tape by operating an operation button is known (see, for example, Patent Literature 1).

### CITATION LIST

### Patent Literature

Patent Literature 1: JP 2007-3901 A

### SUMMARY OF INVENTION

### Technical Problem

The above-described optical connector cleaning tool uses a rack and pinion mechanism to transmit the movement of an operation button to a winding reel for cleaning tape. In this optical connector cleaning tool, the arc caused by the rotation of the rack of the operation button was circumscribed by the arc caused by the rotation of the pinion gear of the winding reel. As a result, the area where the rack and pinion gear engage is small, making it difficult to fully transmit the transmission force (the movement of the operation button) and forcing the rack to have more teeth in order to move the cleaning tape sufficiently.

The present invention was made in consideration of the above-mentioned problems, and is intended to provide an optical connector cleaning tool that can accurately move the cleaning material by sufficiently transmitting the transmission force (the movement of the operating body) with a simple structure.

### Solution to Problem

The optical connector cleaning tool according to the present invention includes: a main body in which a cleaning material for cleaning the end face of an optical connector is held;

a supply reel on which the cleaning material is wound so that it can be fed out;

a cleaning head to which the cleaning material fed from the supply reel is guided;

a winding reel that winds the cleaning material that has passed through the cleaning head;

an operating body that can be pivoted by operation by an operator; and

a rotary engaging body that engages with the operating body to transmit the movement of the operating body to rotate the winding reel;

in which the arc caused by the pivoting of the operating body is inscribed in the arc caused by the rotation of the rotary engaging body, and the operating body and the rotary engaging body are engaged with each other.

### Advantageous Effects of Invention

The transmission force can be sufficiently transmitted with a simple structure.

### BRIEF DESCRIPTION OF DRAWINGS

FIG. 1 is a perspective view schematically illustrating a cleaning tool 10 according to the present embodiment.

FIG. 2 is a perspective view schematically illustrating the cleaning tool 10 according to the present embodiment.

FIG. 3 is a perspective view illustrating the cleaning tool 10 according to the present embodiment with a right housing 110R removed.

FIG. 4 is a side view illustrating a part of the cleaning tool 10 according to the present embodiment with the right housing 110R removed.

FIG. 5 is a perspective view illustrating the cleaning tool 10 according to the present embodiment with a left housing 110L removed.

FIG. 6 is a side view illustrating a part of the cleaning tool 10 according to the present embodiment with the left housing 110L removed.

FIG. 7(a) is a perspective view illustrating the configuration of a head portion 400 of the cleaning tool 10 according to the present embodiment, FIG. 7(b) is a perspective view of the path of a cleaning material CT in the head portion 400, and FIG. 7(c) is a perspective view of the configuration of a cleaning head holder 410.

FIG. 8 is a schematic view illustrating a ratchet gear 322 and an elastic engaging portion 560 of the cleaning tool 10 according to the present embodiment.

FIG. 9 is a schematic view illustrating a circumference C1 of the ratchet gear 322 and a circumference C2 of the rack portion 564 of a winding operation lever 500 inscribed in each other.

FIG. 10 is a schematic view illustrating a state in which the winding operation lever 500 of the cleaning tool 10 is displaced.

FIG. 11 is a perspective view illustrating a holding adapter 4500 according to another embodiment.

FIG. 12 is a schematic perspective view illustrating a winding operation lever 500-1 according to another embodiment.

FIG. 13 is a schematic view illustrating the winding operation lever 500-1 when it is at a first rotation angle.

FIG. 14 is a schematic view illustrating the winding operation lever 500-1 when it is at a second rotation angle.

### DESCRIPTION OF EMBODIMENTS

<<<<Outline of Embodiments>>>>

<<First Aspect>>

A first aspect is an optical connector cleaning tool, including:

a main body (for example, a storage area 160 described below) in which a cleaning material (for example, a cleaning material CT described below) for cleaning the end face of an optical connector is held;

a supply reel on which the cleaning material is wound so that it can be fed out (for example, a supply reel 200 described below);

a cleaning head to which the cleaning material fed from the supply reel is guided (for example, a cleaning head portion 412 described below);

a winding reel (for example, a winding reel 300 described below) that winds the cleaning material that has passed through the cleaning head;

an operating body that can be pivoted by operation by an operator (for example, a winding operation lever 500 described below); and

a rotary engaging body (for example, a ratchet gear 322 described below) that engages with the operating body to transmit the movement of the operating body to rotate the winding reel;

in which the arc caused by the pivoting of the operating body (for example, a circumference C2 of a rack portion 564 of the winding operation lever 500 described below) is inscribed in the arc caused by the rotation of the rotary engaging body (for example, a circumference C1 of a ratchet gear 322 described below), and the operating body and the rotary engaging body are engaged with each other.

The optical connector cleaning tool includes a main body, a supply reel, a winding reel, a cleaning head, an operating body, and a rotary engaging body.

The main body houses a cleaning material. The cleaning material is a member for cleaning an end face of an optical connector. The cleaning material has a layer that can retain contaminants (hereinafter referred to as the retainable layer). For example, some cleaning materials clean the end face of an optical connector by wiping. The cleaning material may be one that is made of nonwoven fabric or woven fabric, and wipes over the end face of the optical connector to remove and capture dust and trash, making it difficult for the dust and trash to leave. The cleaning material may be one that can remove contaminants (such as dust) from the end face of the optical connector by pressing the retainable layer against the end face of the optical connector, causing the contaminants present on the optical connector to be transferred to the retainable layer. Regardless of which cleaning material is used, the supply holder holds the cleaning material in such a manner that the cleaning material can be supplied (fed).

The cleaning material preferably has a long shape. The cleaning material is preferably flexible. For example, it can be tape-shaped or thread-shaped. The cleaning material should be able to be stored in the supply holder in a feedable manner. The size and shape of the cleaning material can be selected as long as it can be supplied from the main body to the cleaning head to clean the end face of an optical connector.

The cleaning head is separated from the main body and held in a fixed holding position relative to the main body. The cleaning head is preferably held in place by an elastic body such as rubber or spring, and the cleaning head preferably returns to a fixed position relative to the main body even when vibrations, impacts, or other forces are applied. The cleaning material supplied from the main body is positioned in the cleaning head. In this configuration, the cleaning head hardly changes its relative position or relative distance from the main body during cleaning work, so the optical connector cleaning tool (main body, cleaning head, etc.) can be kept in a constant posture while pressing the cleaning material on the end face of the optical connector, and contaminants can be accurately removed from the end face of the optical connector and trapped or transferred to the retainable layer.

The end face of the optical connector is an end face of a ferrule of the optical connector. The ferrule is a component used to hold optical fibers in an optical connector. End faces of the optical fibers are disposed on an end face of the ferrule. Communication can be performed by facing the end faces or the optical fibers of an optical connector and the end faces of the optical fibers of an optical cable. When a contaminant such as dust is present between the end faces of the optical fibers of the optical connector and the end faces of the optical fibers of the optical cable, the contaminant may increase the optical loss, making it difficult to accurately transmit information from one optical fiber group to the other optical fiber group. A contaminant is a foreign substance that interferes with communication between optical cables facing each other due to refractive index changes or physical blockage. For example, contaminants include slight soil, small trash (for example, fiber waste), and wipe stains such as alcohol.

The main body holds the cleaning material. The cleaning material is wound on a supply reel. The cleaning material is fed from the supply reel. The winding reel winds the cleaning material that has passed through the cleaning head.

The operating body can be operated by an operator. The operating body can be pivoted by the operator. Pivoting means forward and backward rotation at an angle of 360 degrees or less. For example, the operating body can be rotated clockwise or counterclockwise.

The rotary engaging body can be engaged with the operating body. The operating body does not need to be always engaged with the rotary engaging body. The operating body can be engaged with the rotary engaging body when operated by the operator, and disengaged from the rotary engaging body when the operation is completed.

The rotary engaging body is engaged with the operating body to transmit the movement of the operating body and rotate the winding reel.

As the operating body is pivoted, it forms a circular arc (part of a circumference) trajectory. As the rotary engaging body rotates, it forms a circular trajectory. The arc of the operating body is inscribed with the circumference of the rotary engaging body. The arc of the operating body and the circumference of the rotary engaging body are inscribed in each other to engage the operating body with the rotary engaging body.

By inscribing the arc of the operating body and the circumference of the rotary engaging body, the operating body can be moved along the rotary engaging body, and the area where the operating body approaches or contacts the rotary engaging body can be extended. This expands the area of engagement between the operating body and the rotary engaging body, and allows the movement of the operating body to be accurately transmitted to the rotary engaging body.

The movement of the operating body can be transmitted to the rotary engaging body by, for example, a rack and pinion mechanism. Since the area of engagement between the operating body and the rotary engaging body can be expanded, even if the number of teeth on the rack side is reduced, the state of engagement is maintained, so the movement of the operating body can be accurately transmitted and the configuration of the transmission mechanism can be simplified.

<<Second Aspect>>

A second aspect is an optical connector cleaning tool according to the first aspect,

in which the operating body has a first end (for example, a first end 540 described below) and a second end (for example, a second end 550 described below) facing the first end,

the operating body is pivotable about the first end, and

the operating body includes a stretchable elastic body (for example, a coil spring 580 described below) at the second end.

The operating body has a first end and a second end. The second end is spaced apart from the first end. The operating body can be pivoted around the first end by the operator. A stretchable elastic body is provided at the second end of the operating body. Since the operating body pivots around the first end, the second end, which is separated from the first end, is the part where force can be applied most easily. By providing a stretchable elastic body at the second end, an urging force of the elastic body can be efficiently applied to the operating body. For example, after the operation is finished, the operating body can be accurately returned to its original position (the standard position described below) by efficiently applying the urging force of the elastic body.

<<Third Aspect>>

A third aspect is an optical connector cleaning tool according to the first aspect, in which the diameter of the outer circumference formed by the rotation of the rotary engaging body is the same as the diameter of the winding reel.

Since the diameter of the periphery formed by the rotation of the rotary engaging body is the same as the diameter of the winding reel, the outer circumference of the rotation of the rotary engaging body can be made the largest, and since the force from the operating body is transmitted at the furthest position from the center, the rotary engaging body can be rotated with a small force, resulting in better operability.

<<Fourth Aspect>>

The fourth aspect is the optical connector cleaning tool according to the first aspect, in which the main body has an opening (for example, a winding operation lever opening 170 described below) for operably protruding the operating body,

the operating body has a recess (for example, a recess 520 described below) facing the end of the opening (for example, an engaging end 174 described below),

the state in which the end of the opening is contained in the recess is the standard position of the operating body, and

at least a part of the recess is covered by the end of the opening when the operating body is operated by an operator (for example, the state illustrated in FIG. 10 below).

The operating body can move in and out of the opening. For example, the operating body can be pushed in and out through the opening. The operating body has a recess, which faces the end of the opening. The state in which the end of the opening is housed in the recess can be used as the standard position of the operating body. Specifically, the standard position of the operating body can be the state in which the end of the opening is in contact with the bottom of the recess or the like to define a certain position of the operating body.

When the operating body is operated, the recess may be separated from the end of the opening as the operating body moves. When separated from the end of the opening, at least a part of the recess is still covered by the end of the opening. Although an opening is essential to provide an operating body, it is also expected that the opening can be opened by operation. When the opening is opened, dust may enter and contaminate the cleaning material. However, since at least a part of the recess is covered by the end of the opening, preventing dust from entering the interior.

<<Fifth Aspect>>

A fifth aspect is the optical connector cleaning tool according to the first aspect, further including a guide (for example, a cleaning material guide plate 156 described below) that guides the cleaning material that is fed from the supply reel and reaches the cleaning head.

The guide guides the cleaning material that is fed from the supply reel to the cleaning head. For example, even when the cleaning material fed from the supply reel is loosened due to vibration of the optical connector cleaning tool or impact to the optical connector cleaning tool, the guide prevents the portions of the cleaning material from coming into contact with each other and becoming entangled, and allows the cleaning material to be smoothly supplied to the cleaning head portion. It can also prevent the clean cleaning material fed from the supply reel from being contaminated by contact with other members.

<<<<Details of Embodiments>>>>

Embodiments will be described below with reference to drawings.

<<<<Cleaning Tool 10>>>>

A cleaning tool 10 is an optical connector cleaning tool to clean the end face of a ferrule of an optical connector using a cleaning material CT.

<<<Direction>>>

The directions used herein are described below.

<Front, Rear, and Longitudinal>

The side or direction in which a head portion 400 of the cleaning tool 10 is located is referred to as the front side or front direction, and the side or direction in which the housing 100 is located relative to the head portion 400 is referred to as the rear side or rear direction. The front-rear direction may also be referred to as the longitudinal direction.

<Right and Left>

The right side or direction from the rear side to the front side is referred to as the right side or right direction, and the left side or direction from the rear side to the front side is referred to as the left side. The left-right direction may be referred to as the transverse direction. The left-right direction is perpendicular to the longitudinal direction.

<Lower and Upper>

The side or direction in which a winding operation lever 500 protrudes from the housing 100 is referred to as the upper side, upper direction, or top. The opposite side or direction of the winding operation lever 500 protruding from the housing 100 is referred to as the lower side, downward, or bottom. The lower side or downward, or bottom may be referred to as the bottom. The up-down direction is perpendicular to the front-rear and left-right directions.

<Upstream and Downstream>

The side that feeds and supplies the cleaning material CT is referred to as upstream, and the side that the cleaning material CT is wound up is referred to as downstream. A supply reel 200 and a winding reel 300 described later are upstream and downstream, respectively.

<Forward and Reverse Rotation>

The forward rotation of the supply reel 200 and the winding reel 300 described below is the rotation in the direction that can supply the cleaning material CT to a cleaning head portion 412 and also collect the cleaning material CT. Specifically, in FIG. 4 below, counterclockwise rotation is positive rotation for the supply reel 200, and clockwise rotation is positive rotation for the winding reel 300. In FIG. 6, clockwise rotation is positive rotation for the supply reel 200, and counterclockwise rotation is positive rotation for the winding reel 300.

Reverse rotation of the supply reel 200 and the winding reel 300 means rotation in the direction that the cleaning material CT cannot be supplied to the cleaning head portion 412, and rotation in the direction that the cleaning material CT cannot be collected.

<Cleaning Material CT>

The cleaning material CT is long, flexible, and has at least a resin layer, and can remove dust and other soil when the resin layer comes in contact with the connector end face and the guide pins GP. The cleaning material CT is long, flexible, and made of fibers such as nonwoven fabric or woven fabric, and can remove and capture dust and trash, and entangle and hold the dust and trash. The cleaning material CT has an integral and continuous shape, for example, a tape-like shape or a thread shape.

The width of the cleaning material CT is not limited, but it can be at least the width of the end face ES of the ferrule FE of the optical connector to be cleaned, or even more than the width including the guide pins GP.

The thickness of the cleaning material CT is not limited, and may be, for example, from 0.05 mm to 2 mm.

The cleaning material CT may be a resin layer alone or may be laminated on a base material. A release film may also be laminated on top of it. The base material may be used as a support material when the resin layer alone cannot be supported as a cleaning material CT. The release film can be used to protect the cleaning surface of the cleaning material CT from soil and damage while the cleaning tool 10 of the present invention is not in use.

The cleaning material CT is sent to the cleaning material head and is brought into contact with the end face ES and guide pins GP of the ferrule FE of the optical connector on the cleaning material head. At this time, the base material is stacked on the surface of the resin layer to be brought into contact with the cleaning material head. The release film is stacked on the surface of the resin layer opposite to the base material. The release film is released and excluded from the cleaning material CT before the cleaning material CT reaches the cleaning material head.

The resin layer is not particularly limited as long as soil can be removed by contact with the end face ES of the ferrule FE of the optical connector and the guide pins GP, and examples thereof include an adhesive, a resin foam, a flexible resin in which the guide pins GP can be buried, or allows the guide pins GP to pierce or penetrate therethrough, nonwoven fabric, and woven fabric.

The adhesive may be made of any known material, such as rubber adhesive, acrylic adhesive, silicone adhesive, or urethane adhesive. These adhesives may be blended with additives such as tackifying agents and fillers. The advantage of known adhesives is that they are readily available and their adhesive strength and anti-sticking effect can be easily modified.

The adhesive may be any adhesive as long as it has the ability to adhere soil to the cleaning material CT by contact, and may be, for example, an olefin adhesive with weak adhesive properties. The adhesive is preferably treated to inhibit or prevent contamination of the connector end face, such as glue residue, when it comes into contact with the connector end face and guide pins GP.

The resin foam (foam) may be a known one. Although the mechanism by which the cleaning surface formed by the resin foam traps soil needs to be verified for clarification, one possible example is that soil pressed against the flexible cleaning surface becomes buried (or semi-buried) in the resin foam, making it difficult for the soil to leave the cleaning surface, and is trapped by the resin foam.

In another example, when the end face ES of the ferrule FE or the guide pins GP of the optical connector are pressed against the resin foam, the cells in the resin foam are crushed and the atmosphere inside is forced out. In addition, some of the open cells are crushed and blocked. At this time, the surface of the resin foam adsorbed on the end face ES of the ferrule FE and the surface of the guide pins GP of the optical connector under reduced pressure. Further, it is considered as an example that small trash is sucked into the cells, and trash larger than the cells is adsorbed as the cells are depressurized.

As a result of various verifications, it was ascertained that the resin foam does not cause foreign matter to adhere to the guide pins GP even if the foam is penetrated by the guide pins GP. This is because the resin foam is a very flexible material due to its cells, and the guide pins GP can easily pierce and penetrate it. Therefore, when the guide pins GP pierce and penetrate the resin foam, the resin foam gets entangled in the side part of the guide pins GP, which is thought to efficiently remove trash from the side part of the guide pins GP. Other than resin foam, any material that does not cause foreign matter to adhere to the guide pins GP due to penetration can be suitably used.

The material of the resin foam is not particularly limited, and any known material may be used. Examples of the material include resin foams containing a urethane resin, a (meth)acrylic resin, a saturated polyester resin, a vinyl acetate resin, a vinyl chloride resin, an epoxy resin, an olefin resin, a styrene resin, a melamine resin, a urea resin, a phenolic resin, and a silicone resin. These materials may be used alone or in combination of two or more thereof. Among them, urethane foams are suitable because they have excellent flexibility and low compressive residual strain. A (meth)acrylic foam is also preferable because it has superior strength, light weight, and heat insulation properties. The resin foam is preferably a mixture of urethane foam and (meth)acrylic foam, because their properties can be adjusted to suit the application by changing the mixing ratio.

The structure of the cells contained in the resin foam is not particularly limited, and may be any known structure. The structure of the cells may be a closed cell structure in which the cells exist independently in the resin foam, or an open cell structure in which the cells are continuously connected in the resin foam. In the open cell structure, the cells are connected by communication through holes, or connected by breaking the wall portion of the closed cells. As mentioned above, a resin foam with an open cell structure is preferable because the guide pins GP can easily pierce or penetrate the resin foam and efficiently remove trash.

The method for producing the resin foam is not particularly limited, and may be a known method. For example, the resin foam may be produced by either chemical or physical foaming, and may be an open cell foam produced by forming closed cells and then physically crushing the cells to make them interconnected. For example, the method for producing a foam disclosed in Patent Publication No. 2012-56985 is preferable.

The flexible resin may be a known one, and examples thereof include a polyurethane resin and a polyacrylic resin. Other examples include gel materials made from them. Examples of the gel material include soft polyurethane resins, commonly called polyurethane gel. The gel material is easily deformed, and at the same time, the guide pins GP can easily be buried therein, or pierce or penetrate it. Even if the adhesive strength of the gel material is weak in this case, the soil can be removed from the end face of the optical connector or the guide pins GP by burying the soil in the soft polyurethane or by piercing or penetrating the soil into the soft polyurethane.

In addition, since the gel material is slightly adhesive, the optical connector can be easily detached and reattached without leaving any adhesive residue. Furthermore, the surface of the soiled flexible polyurethane can be reused by cleaning it with a dust-free cloth wetted with water. Preferable examples of the flexible polyurethane include the flexible composition disclosed in JP 2001-316448 A.

The material of the base material is not limited, and may be any known material. For example, resins such as synthetic and natural resins, rubbers such as natural and synthetic rubbers, natural and synthetic fibers, textiles, paper, formed into sheets may be used as base materials. Any of these materials may be used as long as they do not interfere with the effect of the present invention. For example, extruded resin sheets, narrow-cut resin sheets, twisted fibers, weaved fibers (mesh materials, woven fabrics, etc.), laminated fabrics, nonwoven fabrics, and paper may be used.

An example of the woven fiber is a mesh material having a mesh structure with a mesh size of about 0.5 to 2.0 mm.

In a case where the cleaning material CT is deformed so as to follow the shape of the guide pins GP and the hole when the cleaning material CT and the optical connector come into contact with each other, the cleaning material CT needs to have flexibility, and therefore the base material is preferably an olefin or polyvinyl chloride synthetic resin.

On the other hand, in a case where the guide pins GP penetrate the cleaning material CT when the cleaning material CT and the optical connector come into contact with each other, it is preferable to use a base material with a structure that can be easily penetrated or made of a material that can be easily penetrated. For example, braided fibers composed of a mesh, resin films such as polyethylene terephthalate, laminated fabrics, and nonwoven fabrics can be preferable.

When a material containing voids such as braided fibers, a laminated fabric, or a nonwoven fabric is used as the base material, a part of the resin layer may be made to penetrate (impregnate) into the voids of the base material. This ensures a strong adhesion between the base material and the resin layer. Therefore, when the end face ES of the ferrule FE and the guide pins GP of the optical connector are detached from the cleaning material CT, the resin layer is detached from the base material and adheres to the end face ES of the ferrule FE and the guide pins GP of the optical connector, which is advantageous in that adhesive residue hardly occurs.

Preferable examples of the base material made of a material that are easy to penetrate include paper, nonwoven fabrics, woven fabrics, and resin films. The resin that is easy to penetrate is not limited, and preferable examples thereof include resins that break easily after exhibiting a certain level of elongation, such as polyolefin resins such as polyethylene resins, and resins with an easy-cutting finish, such as uniaxially or biaxially stretched polypropylene (PP) or polyethylene terephthalate (PET).

The material of the release film may be any known material and is not limited. It may be a sheet material, such as a resin film or paper, with a peel-off finish on the resin layer side. The peel-off finish is not limited to any particular method, and examples thereof include application of a peeling agent such as dimethylsiloxane.

<<<<Configuration of Cleaning Tool 10>>>>

The cleaning tool 10 mainly includes the housing 100, the supply reel 200, the winding reel 300, the head portion 400, and the winding operation lever 500. The housing 100, the supply reel 200, the winding reel 300, the head portion 400, and the winding operation lever 500 are made of ABS resin (acrylonitrile-butadiene-styrene copolymer synthetic resin) or POM (polyacetal) resin.

<<<Overview of Housing 100>>>

The housing 100 houses the supply reel 200 and the winding reel 300 in a rotatable manner. The unused portion of the cleaning material CT is wound on the supply reel 200. The unused portion of the cleaning material CT is wound on the winding reel 300. The unused portion of the cleaning material CT from the supply reel 200 is guided to the cleaning head portion 412, which makes contact with the end face of the ferrule of the optical connector to clean the end face, and the used portion of the cleaning material CT is wound on the winding reel 300.

The housing 100 has an elongated shape as a whole. The housing 100 houses the supply reel 200 and the winding reel 300 along the longitudinal direction. In the housing 100, the winding reel 300 is located at the front side and the supply reel 200 is located at the rear side. The winding reel 300 may be positioned at the rear side and the supply reel 200 may be positioned at the rear side. The housing 100 has an elongated shape as a whole.

<<<Configuration of Housing 100>>>

The housing 100 includes a right housing 110R and a left housing 110L. The right housing constitutes the right portion of the housing 100, and the left housing constitutes the left portion of the housing 100. The right housing 110R has locking claws 154, and the left housing 110L has locking holes 152. The outer shape of the right housing 110R is roughly linearly symmetrical with that of the left housing 110L. The housing 100 is integrally formed by placing the right housing 110R and left housing 110L facing each other and locking the locking claws 154 of the right housing 110R in the locking holes 152 of the left housing 110L.

<<Right Housing 110R>>

The right housing 110R constitutes the right portion of the housing 100.

<Remaining Amount Check Window 120>

A remaining amount check window 120 is formed in the right housing 110R. The remaining amount check window 120 is a through hole for viewing the amount of remaining cleaning material CT wound on the supply reel 200 (remaining amount). It is formed along the radial direction of the supply reel 200. The operator can check the remaining amount of the cleaning material CT and proceed with the operation.

<Supply Reel Holding Protrusion 118>

The supply reel holding protrusion 118 is formed in the right housing 110R. The supply reel holding protrusion 118 protrudes from the right housing 110R toward the left housing 110L. The supply reel holding protrusion 118 holds the supply reel 200 in a rotatable manner.

<Winding Reel Holding Protrusion 116>

The winding reel holding protrusion 116 is formed in the right housing 110R. The winding reel holding protrusion 116 protrudes from the right housing 110R toward the left housing 110L. The winding reel holding protrusion 116 holds the winding reel 300 in a rotatable manner.

<Locking Claw 154>

The locking claws 154 are provided in a plurality of locations along the outer circumference of the right housing 110R. The locking claws 154 engage with the locking holes 152 in the left housing 110L to connect the right housing 110R to the left housing 110L.

<Cleaning Material Guide Plate 156>

The right housing 110R has a cleaning material guide plate 156. The cleaning material guide plate 156 is provided at the bottom of the right housing 110R. The cleaning material guide plate 156 is plate-shaped. There is a gap 158 between the cleaning material guide plate 156 and the right housing 110R. In the gap 158, the cleaning material CT fed from the supply reel 200 is guided in a movable manner. Even when the cleaning material CT fed from the supply reel 200 is loosened due to vibration of the cleaning tool 10 or impact on the cleaning tool 10, the portions of the cleaning material CT can be prevented from touching each other and becoming entangled, and the cleaning material CT can be smoothly supplied to the cleaning head portion 412. This also prevents the clean cleaning material CT fed from the supply reel 200 from being contaminated by contact with other members. Furthermore, the cleaning material guide plate 156 reinforces a storage area 160 of the right housing 110R, thereby increasing its durability.

<<Left Housing 110L>>

The left housing 110L constitutes the left portion of the housing 100.

<Locking Hole 152>

Locking holes 152 are provided in the left housing 110L. The locking holes 152 are located along the outer circumference of the left housing 110L, corresponding to the locking claws 154 of the right housing 110R. The locking holes 152 engage with the locking claws 154 of the right housing 110R to connect the right housing 110R to the left housing 110L.

<<Winding Operation Lever Opening 170, Storage Area 160, and Cleaning Material Guide 180>>

The housing 100 includes a winding operation lever opening 170, a storage area 160, and a cleaning material guide 180.

<Winding Operation Lever Opening 170>

The right housing 110R and left housing 110L have notches. The notches of the right housing 110R and the left housing 110L face each other, and these notches constitute the winding operation lever opening 170 of the housing 100.

By forming the winding operation lever opening 170, a part of the winding operation lever 500 can be made to protrude from the housing 100. The operator can operate the winding operation lever 500 so as to push the winding operation lever 500 into the housing 100.

The winding operation lever opening 170 is provided not above the supply reel 200 but above the winding reel 300. This configuration makes it difficult for the unused portion of the cleaning material CT on the supply reel 200 to be contaminated even when dust enters from outside through the winding operation lever opening 170.

<Open Wall 172>

An open wall 172 is formed in the left housing 110L. The open wall 172 is formed as an open wall of the winding operation lever opening 170. The open wall 172 has an arc shape centered on a pivoting protruding pin 544 described below.

<Engaging End 174>

The right housing 110R and left housing 110L have an engaging end 174 at the end of the winding operation lever opening 170. The engaging end 174 has a flat shape and can enter into a recess 520 of the winding operation lever 500 described below.

<<Storage Area 160>>

The storage area 160 has a certain width W1 (see FIG. 2). The storage area 160 houses the supply reel 200 and the winding reel 300 in a rotatable manner. As described above, the winding reel 300 is located at the front side (closer to the head portion 400) and the supply reel 200 is located at the rear side (farther from the head portion 400). The storage area 160 covers the entire cleaning material CT to prevent it from being contaminated by dust from outside.

<<Cleaning Material Guide 180>>

The cleaning material guide 180 protrudes and extends from the storage area 160. The cleaning material guide 180 has a long shape. The cleaning material guide 180 has a widened portion 184, a narrowed portion 186, and a transitional connection 188. The widened portion 184 is connected to the storage area 160. The widened portion 184 has the same width W1 as the storage area 160.

The cleaning material guide 180 guides the cleaning material CT from the storage area 160 to the cleaning head portion 412 (outward) and from the cleaning head portion 412 to the storage area 160 (inward). The cleaning material guide 180 forms outward and inward paths of the cleaning material CT. The outward and inward paths of the cleaning material CT are formed with the head portion 400 interposed therebetween.

The cleaning material guide 180, which has a long shape, allows the head portion 400 to reach the end face ES of the ferrule FE of the optical connector by diving through a large number of optical fibers connected to the installed equipment. In this manner, the cleaning head portion 412 of a cleaning head holder 410 faces the end face ES of the ferrule FE of the optical connector.

<Widened Portion 184>

The widened portion 184 houses the outward and inward cleaning material CT. The widened portion 184 has a long columnar shape.

<Transitional Connection 188>

The transitional connection 188 protrudes and extends from the widened portion 184. The width of the transitional connection 188 gradually changes in width from W1 to W2, and connects to the narrowed portion 186.

The widened portion 184 and the transitional connection 188 have ribs 185R and 185L. The rib 185R is provided in the right housing 110R, and the rib 185L is provided in the left housing 110L. The ribs 185R and 185L have a long, plate-like shape. The ribs 185R and 185L are provided along the longitudinal direction of the widened portion 184 and the transitional connection 188.

The outward portion of the cleaning material CT is guided below the ribs 185R and 185L, and the inward portion of the cleaning material CT is guided above the ribs 185R and 185L. The ribs 185R and 185L prevent contact between the outward and inward portions of the cleaning material CT. They prevent the dusty inward portion of the cleaning material CT from contaminating the clean outward portion of the cleaning material CT.

The ribs 185R and 185L reinforce the long widened portion 184 and the transitional connection 188, and prevent deformation of the widened portion 184 and the transitional connection 188 to guide the cleaning material CT smoothly. In addition, they increase the durability of the widened portion 184 and the transitional connection 188.

<Narrowed Portion 186>

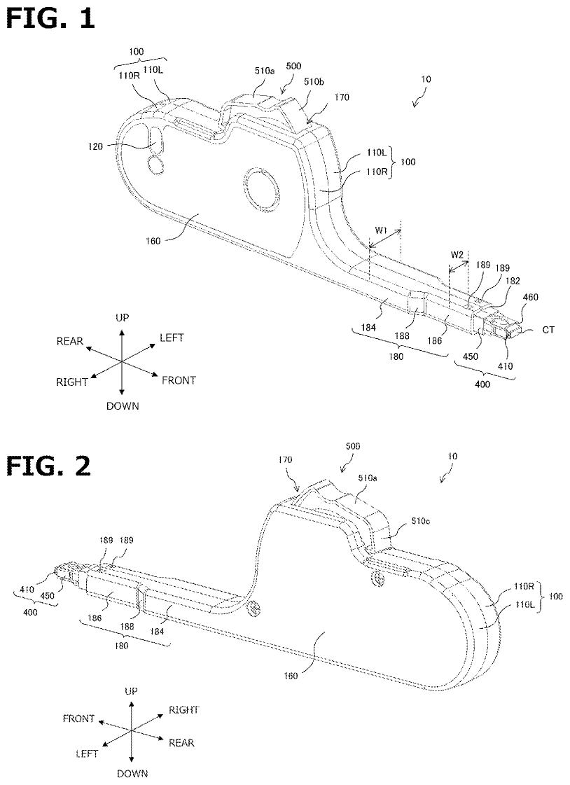

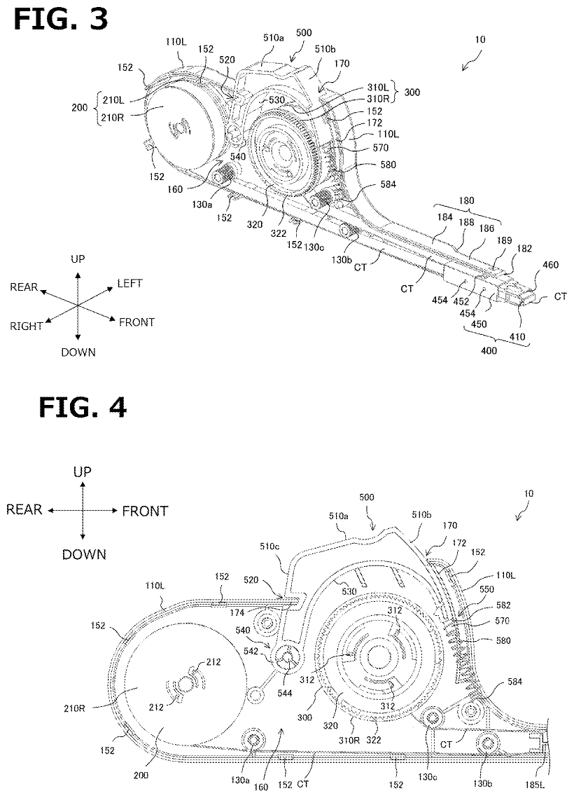

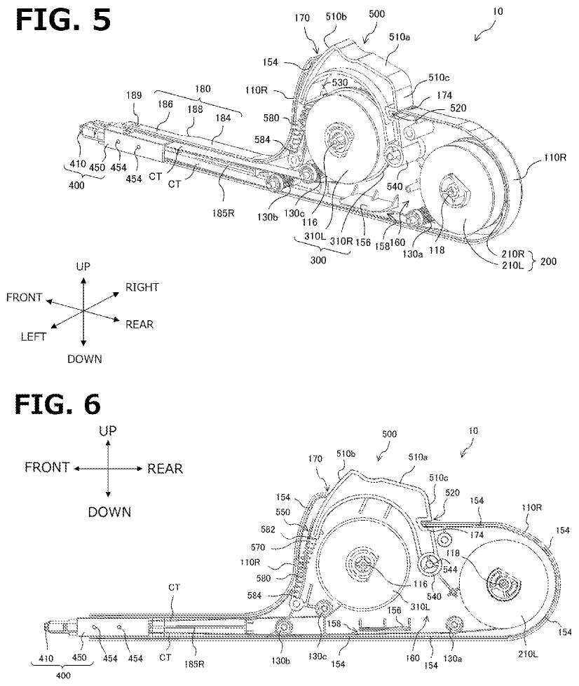

The narrowed portion 186 protrudes and extends from the transitional connection 188. The narrowed portion 186 has a narrower width W2 than the widened portion 184 (see FIG. 1). The narrowed portion 186 holds a holding adapter 450 of the head portion 400 described later.

<Holding Adapter Opening 182>

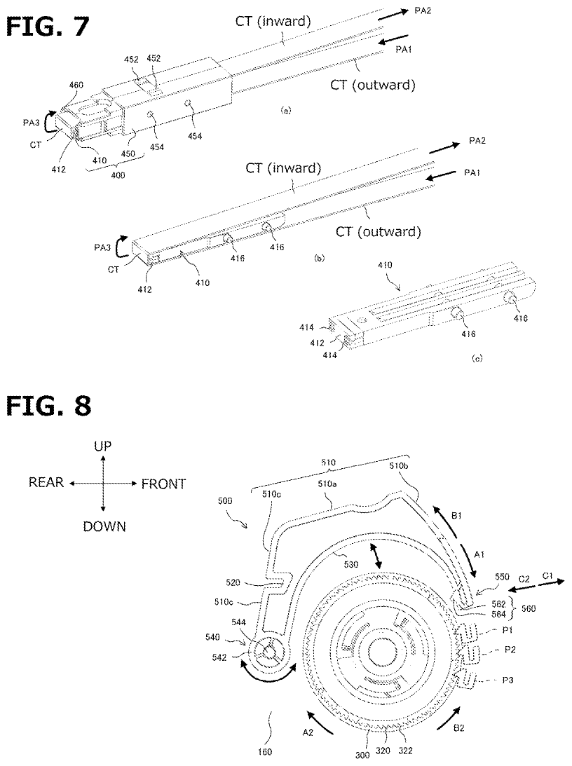

A holding adapter opening 182 is formed at the tip of the narrowed portion 186 (the side facing the end face ES of the ferrule FE of the optical connector). Head portion holding locking holes 189 are formed near the holding adapter opening 182. By engaging holding protrusions 452 (FIG. 7(a)) of the holding adapter 450 in the head portion holding locking holes 189, the holding adapter 450 is held in the cleaning material guide 180 and the holding adapter 450 is protruded from the holding adapter opening 182.

<Cleaning Material Supply Guide Roller 130a and Cleaning Material Supply Guide Roller 130b>

A cleaning material supply guide roller 130a and a cleaning material supply guide roller 130b are provided across the right housing 110R and the left housing 110L in a rotatable manner. The cleaning material supply guide roller 130a and the cleaning material supply guide roller 130b have a substantially cylindrical shape. The cleaning material supply guide roller 130a and the cleaning material supply guide roller 130b come into contact with the cleaning material CT and bend the cleaning material CT to change the direction of movement of the cleaning material CT.

The cleaning material supply guide roller 130a and the cleaning material supply guide roller 130b guide the cleaning material CT fed from the supply reel 200 toward the head portion 400. The cleaning material supply guide roller 130a and the cleaning material supply guide roller 130b guide the cleaning material CT to the head portion 400 by adjusting the direction of the cleaning material CT to the head portion 400 to be a certain direction without depending on the remaining amount of the cleaning material CT wound on the supply reel 200 (the radius of the cleaning material CT). Since the cleaning material supply guide roller 130a and the cleaning material supply guide roller 130b guides the cleaning material CT while they are in contact with it, they can suppress vibrations generated in the cleaning material CT by movement and guide the cleaning material CT to the head portion 400 in a stable state.

<Cleaning Material Winding Guide Roller 130c>

A cleaning material winding guide roller 130c guides the cleaning material CT from the head portion 400 to the winding reel 300. The cleaning material winding guide roller 130c are rotatably provided across the right housing 110R and the left housing 110L. The cleaning material winding guide roller 130c has a substantially cylindrical shape. The cleaning material winding guide roller 130c contacts the cleaning material CT and bends the cleaning material CT to change the direction of movement of the cleaning material CT.

Since the cleaning material winding guide roller 130c guides the cleaning material CT while it is in contact with it, it can suppress vibrations generated in the cleaning material CT by movement and guide the cleaning material CT to the winding reel 300 in a stable state.

<<<Supply Reel 200>>>

A supply reel 200 mainly includes a right supply reel frame 210R and a left supply reel frame 210L. The unused portion of the cleaning material CT is wound between the right supply reel frame 210R and the left supply reel frame 210L in a feedable (suppliable) manner. The cleaning material CT is held between the right supply reel frame 210R and the left supply reel frame 210L. As a result, the cleaning material CT can be supplied to the cleaning head portion 412 in a stable form, preventing contact with other materials, etc., and can be supplied to the cleaning head portion 412 in a clean condition.

The right supply reel frame 210R and the left supply reel frame 210L have a substantially disk shape. The right supply reel frame 210R and the left supply reel frame 210L have a through hole in the center. The supply reel 200 is rotatably held by inserting the aforementioned supply reel holding protrusion 118 into the through holes of the right supply reel frame 210R and left supply reel frame 210L.

The right supply reel frame 210R has anti-reverse claws 212. The anti-reverse claws 212 are engaged with a rib (not illustrated) on the right housing 110R. Engagement of the anti-reverse claws 212 with the rib prevents the right supply reel frame 210R from rotating in reverse. The anti-reverse claws 212 also have the function of preventing the cleaning material CT from slackening, so that the claws keep the cleaning material CT stretched and ensure the transmission for supplying the cleaning material CT by operating the winding operation lever 500.

<<<Winding Reel 300>>>

The winding reel 300 includes a right winding reel frame 310R, a left winding reel frame 310L, and a pinion body 320. The used portion of the cleaning material CT is wound between the right winding reel frame 310R and the left winding reel frame 310L. The cleaning material CT is held between the right winding reel frame 310R and the left winding reel frame 310L. This prevents the cleaning material CT from meandering when the cleaning material CT having a long shape is wound up, and allows the cleaning material CT to be wound up accurately on a winding reel 300. As a result, tangling of the portions of the cleaning material CT on the winding reel 300 is prevented, and the cleaning material CT can be wound to the end, preventing waste.

The right winding reel frame 310R and the left winding reel frame 310L have a substantially disk shape. The right winding reel frame 310R and the left winding reel frame 310L each have a through hole in the center. The winding reel 300 is rotatably held by inserting the aforementioned winding reel holding protrusion 116 into the through holes of the right winding reel frame 310R and left winding reel frame 310L.

The right winding reel frame 310R has anti-reverse claws 312. The anti-reverse claws 312 engage with a rib (not illustrated) on the right housing 110R. Engagement of the anti-reverse claws 312 with the rib prevents the right winding reel frame 310R from rotating in reverse.

<Pinion Body 320>

The right winding reel frame 310R includes a pinion body 320. The pinion body 320 is integrally formed on the outside of the right winding reel frame 310R (the side facing the right housing 110R). The pinion body 320 has a substantially cylindrical shape with a low height. The pinion body 320 is formed integrally and coaxially with the right winding reel frame 310 R.

The length of the radius of the pinion body 320 is approximately the same as the radius of the right winding reel frame 310R. That is, the radius of the pinion body 320 is made as large as possible, which reduces the force applied from the winding operation lever 500 described below. This makes it easy to operate the winding operation lever 500.

A ratchet gear 322 is formed along the outer circumference surface of the pinion body 320. The ratchet gear 322 includes a row of teeth with asymmetrical tooth surfaces. The teeth of the ratchet gear 322 are composed of tooth surfaces with a small pressure angle (steeply inclined (largely inclined) tooth surfaces) (hereinafter referred to as largely inclined tooth surfaces) and tooth surfaces with a large pressure angle (tooth surfaces with loose (small) inclination) (hereinafter referred to as slightly inclined tooth surfaces) across the tooth tip. The largely inclined tooth surfaces constitute the engagement surface, and the slightly inclined tooth surfaces constitute the slip surface and sliding surface.

<<<Head Portion 400>>>

The head portion 400 is located protruding from the cleaning material guide 180 toward the front direction. The head portion 400 mainly includes the cleaning head holder 410 and the holding adapter 450 (see FIG. 7(a)).

<<Cleaning Head Holder 410>>

The cleaning head holder 410 mainly includes the cleaning head portion 412, receiving holes 414, and holding pins 416 (see FIG. 7(c)).

<Cleaning Head Portion 412>

The cleaning head portion 412 is located at the tip of the cleaning head holder 410. The cleaning head portion 412 has a size and shape corresponding to the end face ES of the ferrule FE of the optical connector. The cleaning material CT fed from the supply reel 200 is guided to the cleaning head portion 412 (see FIGS. 7(a) and 7(b)) and contacts the end face ES of the ferrule FE of the optical connector.

<Receiving Hole 414>

The cleaning head portion 412 has two receiving holes 414 for receiving the two guide pins GP protruding from the end face ES of the ferrule FE of the optical connector (FIG. 7(c)). The receiving holes 414 allow the resin layer RL of the cleaning material CT to reach the root of the guide pins GP on the end face ES of the ferrule FE of the optical connector, and the dust near the base of the guide pins GP can be accurately removed.

The cleaning head holder 410 has a long, thin, flat, rectangular shape. The cleaning head holder 410 is held in a fixed position on the holding adapter 450 (FIG. 7(a)). The cleaning material CT fed from the supply reel is guided to the cleaning head portion 412 and positioned in the cleaning head portion 412. The cleaning head holder 410 may be detachably provided on the holding adapter 450. The cleaning head holder 410 may be appropriately replaced with a corresponding one depending on the shape and size of the end face ES of the ferrule FE of the optical connector.

The resin layer RL of the cleaning material CT positioned in the cleaning head portion 412 is placed facing the end face ES of the ferrule FE of the optical connector, and when the resin layer RL contacts the end face ES of the ferrule FE of the optical connector, the dust on the end face ES of the ferrule FE of the optical connector is transferred to the resin layer RL. This transposition can remove the dust from the end face ES of the ferrule FE of the optical connector. The cleaning material CT is then wound from the cleaning head portion 412 to the winding reel 300.

<Holding Pin 416>

Two holding pins 416 protrude from the right and left sides of the cleaning head holder 410, respectively. The holding pins 416 are engaged with pin-holding through holes 454 of the holding adapter 450.

<<Holding Adapter 450>>

The holding adapter 450 has a long, constant shape (FIG. 7(a)). The holding adapter 450 has a long, rectangular cylindrical shape and a hollow structure. The holding adapter 450 holds the cleaning head holder 410 in a fixed position relative to the cleaning material guide 180. That is, the cleaning head holder 410 is held in the cleaning material guide 180 via the holding adapter 450.

The holding adapter 450 houses the cleaning material CT from the supply reel 200 to the winding reel 300 in a movable manner. Specifically, the holding adapter 450 movably houses the cleaning material CT from the supply reel 200, through the cleaning head portion 412 of the cleaning head holder 410 described above, until it is wound onto the winding reel 300. The holding adapter 450 mainly includes the holding protrusions 452 and pin-holding through holes 454.

<Holding Protrusion 452>

The holding protrusions 452 protrude from the holding adapter 450. By inserting the holding protrusions 452 into the head portion holding locking holes 189 formed in the narrowed portion 186, the holding adapter 450 is held in the narrowed portion 186 (cleaning material guide 180).

<Pin-Holding Through Hole 454>

Two pin-holding through holes 454 are formed on the right side and left side of the holding adapter 450. The holding pins 416 of the cleaning head holder 410 are inserted into the pin-holding through holes 454. The pin-holding through holes 454 and the holding pins 416 allow the cleaning head holder 410 to be held in a fixed position on the holding adapter 450 and the cleaning head holder 410 to protrude from an opening for head portion 460. In this manner, the cleaning head portion 412 can be positioned to face the end face ES of the ferrule FE of the optical connector.

<<<Winding Operation Lever 500>>>

The winding operation lever 500 can be operated by an operator. The operator who cleans the end face ES of the ferrule FE of the optical connector operates the winding operation lever 500, thereby moving the cleaning material CT. The movement of the cleaning material CT guides the clean area of the cleaning material CT to the cleaning head portion 412, and presses the clean area of the cleaning material CT against the end face ES of the ferrule FE to remove dust and other soil. In addition, the movement of the cleaning material CT allows the area of the cleaning material CT contaminated by dust and other soil to be stored in the cleaning material guide 180 and wound onto the winding reel 300.

The winding operation lever 500 has an outer circumference surface 510 and an inner circumference surface 530. The winding operation lever 500 has a substantially U-shaped columnar shape. The substantially U-shaped columnar shape is formed by the outer circumference surface 510 and the inner circumference surface 530. The outer circumference surface 510 includes an outer circumference surface 510a, an outer circumference surface 510b, and an outer circumference surface 510c.

<<Outer Circumference Surface 510a, Outer Circumference Surface 510b, Outer Circumference Surface 510c, and Inner Circumference Surface 530>>

The outer shape of the winding operation lever 500 is defined by the outer circumference surface 510a, the outer circumference surface 510b, and the inner circumference surface 530.

<Outer Circumference Surface 510a>

The outer circumference surface 510a is the surface for the operator to perform the winding operation. The operator's fingers come in contact with the outer circumference surface 510a, and a force is applied to the winding operation lever 500. When a force is applied toward the winding reel 300, the winding operation lever 500 is displaced in a direction closer to the winding reel 300. As described below, the winding operation lever 500 can be rotated (pivoted) around the pivoting protruding pin 544.

<Outer Circumference Surface 510b>

The outer circumference surface 510b extends from the end of the outer circumference surface 510a toward a second end 550. The outer circumference surface 510b connects with the inner circumference surface 530 at the second end 550. The outer circumference surface 510b faces the open wall 172 of the storage area 160. The open wall 172 and the outer circumference surface 510b have an arc shape centered on the pivoting protruding pin 544 described below. There is a certain gap (void) between the open wall 172 and the outer circumference surface 510b. Even when the winding operation lever 500 is rotated around the pivoting protruding pin 544, a certain gap between the open wall 172 and the outer circumference surface 510b is maintained. By ensuring a certain gap during the winding operation, the winding operation lever 500 can be moved smoothly. In addition, the constant gap prevents dust from entering the storage area 160 through the gap during the winding operation.

<Outer Circumference Surface 510c>

The outer circumference surface 510c extends from the end of the outer circumference surface 510a toward a first end 540. The outer circumference surface 510c connects with the inner circumference surface 530 at the first end 540. The outer circumference surface 510c has the recess 520. The recess 520 can be entered and contacted by the engaging end 174 of the opening 170 for the winding operation lever. The upper limit position of the winding operation lever 500 can be defined by the contact of the engaging end 174 with the recess 520.

As described below, an urging force is applied to the winding operation lever 500 by a coil spring 580. When the operator removes his hand from the winding operation lever 500, the winding operation lever 500 returns to the upper limit position by the urging force of the coil spring 580. As described above, by contacting the engaging end 174 with the recess 520, the winding operation lever 500 is made in a certain position, and the upper limit position can be made the standard position.

When the winding operation lever 500 is displaced, the engaging end 174 is separated from the recess 520, but the engaging end 174 remains in the recess 520 (see FIG. 10). This prevents dust from entering the storage area 160 through the recess 520 during the winding operation.

<Inner Circumference Surface 530>

The inner circumference surface 530 faces the outer circumference of the winding reel 300. The inner circumference surface 530 and the outer circumference of the winding reel 300 have an arc shape centered on the center of the winding reel 300. Even when the winding operation lever 500 is closest to the winding reel 300, the inner circumference surface 530 and the outer circumference of the winding reel 300 are parallel (separated from each other), and the gap between the inner surface 530 and the outer circumference of the winding reel 300 is maintained. Ensuring the gap prevents the winding operation lever 500 from colliding or coming into contact with the winding reel 300, and keeps the movement of the winding operation lever 500 smooth.

<<First End 540 and Second End 550>>

The winding operation lever 500 has the first end 540 and the second end 550. As described above, the winding operation lever 500 has a substantially U-shaped columnar shape, and the two ends along the U-shape are the first end 540 and the second end 550. The first end 540 and the second end 550 are located across the winding reel 300 and roughly along the diameter direction of the winding reel 300. The first end 540 is positioned between the supply reel 200 and the winding reel 300. The second end 550 can be moved in the direction along the open wall 172.

<Pivoting Holding Portion 542>

The first end 540 has a pivoting holding portion 542. The pivoting holding portion 542 has a substantially cylindrical shape. The pivoting holding portion 542 connects the outer circumference surface 510c of the winding operation lever 500 to the inner circumference surface 530.

<Pivoting Protruding Pin 544>

The pivoting holding portion 542 has the pivoting protruding pin 544. The pivoting protruding pin 544 is formed in the center of the pivoting holding portion 542. The pivoting protruding pin 544 protrudes from the pivoting holding portion 542 along the central axis. The pivoting protruding pin 544 serves as the central axis of the pivoting holding portion 542. The right housing 110R and the left housing 110L have holding holes (not illustrated). The pivoting protruding pin 544 is housed by protruding toward the holding holes of the right housing 110R and the left housing 110L. The holding holes are formed in both the right housing 110R and the left housing 110L. In this manner, the winding operation lever 500 can be rotated (pivoted) around the pivoting protruding pin 544. That is, the winding operation lever 500 can be pivotably held with the pivoting protruding pin 544 as the rotation center.

<Elastic Engaging Portion 560>

The second end 550 connects the outer circumference surface 510b of the winding operation lever 500 to the inner circumference surface 530. The second end 550 has an elastic engaging portion 560. The elastic engaging portion 560 includes an urging force generating portion 562 and a rack portion 564.

<Rack Portion 564>

The rack portion 564 includes a tooth with asymmetrical tooth surfaces, similar to the teeth of the ratchet gear 322. In the present embodiment, the rack portion 564 has one tooth, but the rack portion 564 may include a plurality of teeth. The tooth of the rack portion 564 is composed of a largely inclined tooth surface (tooth surface with a small pressure angle (steep (large) inclination) and a slightly inclined tooth surface (tooth surface with a large pressure angle (loose (small) inclination) across the tooth tip. The largely inclined tooth surface constitutes an engagement surface, and the slightly inclined tooth surface constitutes a slip surface and a sliding surface.

The ratchet gear 322 and the rack portion 564 constitute a ratchet mechanism (anti-return mechanism). The state of engagement between the largely inclined tooth surfaces of the ratchet gear 322 of the pinion body 320 and the largely inclined tooth surface of the rack portion 564 of the winding operation lever 500 can define the direction of rotation in which rotation of the winding reel 300 is permitted (permitted rotation direction (for example, clockwise (arrow A2) in FIG. 8). The state of engagement (slidable state) between the slightly inclined tooth surfaces of the ratchet gear 322 of the pinion body 320 and the slightly inclined tooth surface of the rack portion 564 of the winding operation lever 500 can define the direction of rotation in which the rotation of the winding reel 300 is prohibited (prohibited rotation direction (for example, counterclockwise (arrow B2) in FIG. 8).

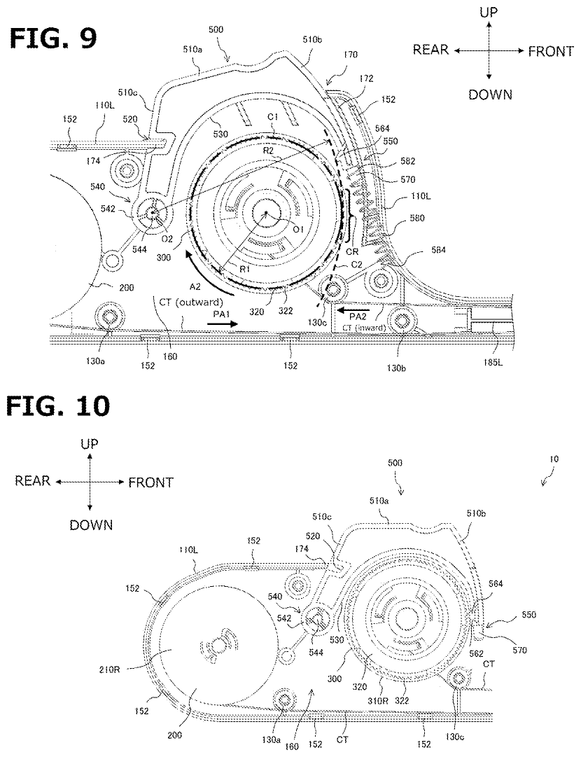

The largely inclined tooth surface of the rack portion 564 engages with the largely inclined tooth surfaces of the ratchet gear 322 of the pinion body 320 of the winding reel 300 in response to the movement of the winding operation lever 500, causing the winding reel 300 to rotate in the permitted rotation direction as the winding operation lever 500 moves. As the winding reel 300 rotates, the cleaning material CT is wound onto the winding reel 300 (arrow A2 in FIG. 9), and the cleaning material CT is displaced (arrows PA1 and PA2 in FIG. 9). The dusty portion of the cleaning material CT contaminated by cleaning is displaced from the cleaning head portion 412 and stored in the cleaning material guide 180, while the clean portion of the cleaning material CT is guided to the cleaning head portion 412. The details of the displacement of the cleaning material CT will be described later.

<Urging Force Generating Portion 562>

The urging force generating portion 562 is elastically deformable and applies an urging force to the rack portion 564. The rack portion 564 can be displaced in the direction of separation from the winding reel 300 by the elastic deformation of the urging force generating portion 562 (see arrow C1 in FIG. 8). The rack portion 564 can be displaced in a direction closer to the winding reel 300 by the urging force generated by the urging force generating portion 562 (see arrow C2 in FIG. 8).

<Coil Spring Locking Protrusion 570>

The second end portion 550 has a coil spring locking protrusion 570. The coil spring locking protrusion 570 locks a first end 582 of the coil spring 580. A second end 584 of the coil spring 580 is locked to a locking hole (not illustrated) of the right housing 110R. The locking hole of the right housing 110R is located at the bottom of the foremost side of the storage area 160. The coil spring 580 can be extended or retracted in response to the operation of the winding operation lever 500 by the operator. When the operator pushes the winding operation lever 500 into the storage area 160, the coil spring 580 contracts and the urging force increases. When the operator removes his hand from the winding operation lever 500, the urging force of the coil spring 580 to extend is applied to the winding operation lever 500, and with the extension of the coil spring 580, the winding operation lever 500 moves toward the standard position.

In this manner, the coil spring 580 is placed at the most front side of the storage area 160 and is stretched and deformed. That is, the coil spring 580 can be installed at the most separated position from the supply reel 200 across the winding reel 300. The coil spring 580 expands and contracts with the operation of the winding operation lever 500, so that even if dust or other particles are generated, they are kept away from the supply reel 200, thus preventing contamination of the clean cleaning material CT.

<<<Movement of Ratchet Mechanism>>>

<<When Force is Applied to Winding Operation Lever 500>>

<Engagement of Ratchet Gear 322 with Rack Portion 564>

When the winding operation lever 500 is pushed into the storage area 160 by the operator, the elastic engaging portion 560 gradually moves downward (see arrow A1 in FIG. 8). As the elastic engaging portion 560 moves downward, the largely inclined tooth surfaces of the ratchet gear 322 of the winding reel 300 engage with the largely inclined tooth surface of the rack portion 564 of the winding operation lever 500 (see P1 in FIG. 8). This engagement between the largely inclined tooth surfaces transmits a force that can rotate the winding reel 300 from the rack portion 564 of the winding operation lever 500 to the ratchet gear 322 of the winding reel 300 as the elastic engaging portion 560 moves downward (P1→P2→P3 in FIG. 8). The downward movement of the elastic engaging portion 560 (see arrow A1 in FIG. 8) transmits a force that allows the winding reel 300 to rotate in a clockwise direction (see arrow A2 in FIGS. 8 and 9). In the example illustrated in FIG. 8, clockwise is the permitted rotation direction. The largely inclined tooth surface of the rack portion 564 of the winding operation lever 500 and the largely inclined tooth surfaces of the ratchet gear 322 of the winding reel 300 constitute a rack and pinion mechanism to transmit a force.

<Pulling and Supply of Cleaning Material CT>

When the winding operation lever 500 moves in the direction of being pushed into the storage area 160, the rack and pinion mechanism transmits the force to the winding reel 300, causing the winding reel 300 to rotate (see arrow A2 in FIGS. 8 and 9). As the winding reel 300 rotates, the cleaning material CT is pulled (see arrow PA1 in FIG. 9) and wound around the winding reel 300. As the cleaning material CT is pulled, the cleaning material CT is newly fed from the supply reel 200, and the clean resin layer RL of the cleaning material CT is supplied to the cleaning head portion 412 of the cleaning head holder 410 (see arrow PA3 in FIG. 7(a)).

<<When Force Applied to Winding Operation Lever 500 is Weakened (Stopped)>>

<Engagement of Ratchet Gear 322 with Rack Portion 564>

When the force on the winding operation lever 500 is weakened, as described above, the urging force of the coil spring 580 moves the winding operation lever 500 toward the standard position (see arrow B1 in FIG. 8). At this time, the slightly inclined tooth surface of the rack portion 564 of the winding operation lever 500 engages with the slightly inclined tooth surfaces of the ratchet gear 322 of the winding reel 300. The rack portion 564 of the winding operation lever 500 can be deformed in the direction of separation from the ratchet gear 322 of the winding reel 300 by elastic deformation of the urging force generating portion 562 (see arrow C1 in FIG. 8). Therefore, while the slightly inclined tooth surface of the rack portion 564 slides on the slightly inclined tooth surfaces of the ratchet gear 322, the rack portion 564 of the winding operation lever 500 moves in the direction of separation from the teeth of the ratchet gear 322 of the winding reel 300 (see arrow C1 in FIG. 8), allowing the winding operation lever 500 to move toward the standard position.

<Pulling and Supply of Cleaning Material CT>

When the force on the winding operation lever 500 is weakened, the largely inclined tooth surface of the rack portion 564 does not engage with the largely inclined tooth surfaces of the ratchet gear 322, so no force is transmitted from the winding operation lever 500 to the winding reel 300, and the winding reel 300 does not rotate (see arrow B2 in FIG. 8). Therefore, when the force on the winding operation lever 500 is removed, the cleaning material CT will not be pulled and the cleaning material CT will be held in a fixed position.

<<<Pulling of Cleaning Material CT>>>

As described above, the winding reel 300 is rotated when the winding operation lever 500 is pushed into the storage area 160 by the operator, and the cleaning material CT is wound onto the winding reel 300. When the operator's hand is released from the winding operation lever 500, the winding operation lever 500 returns to the standard position. At this time, the winding reel 300 does not rotate and the cleaning material CT does not move. Thus, in the cleaning tool 10, the cleaning material CT is wound onto the winding reel 300 only when the winding operation lever 500 is pushed in.

<<<Enlargement of Proximity Area CR (Engagement Area)>>>

The ratchet gear 322 of the winding reel 300 rotates around the winding reel holding protrusion 116 (hereinafter referred to as a rotation center O1). The ratchet gear 322 moves along a circumference C1. The radius of gyration of the ratchet gear 322 is R1 (see the single-dotted dashed line in FIG. 9). The rack portion 564 of the winding operation lever 500 rotates (pivots) around the pivoting protruding pin 544 (hereinafter referred to as a rotation center O2). The rack portion 564 of the winding operation lever 500 moves along the arc C2. The radius of gyration of the rack portion 564 is R2, which is larger than R1 (see dashed line in FIG. 9). In the following, the circumference formed by the arc C2 will be referred to as the circumference C2.

The circumference C1 of the ratchet gear 322 and the circumference C2 of the rack portion 564 of the winding operation lever 500 are inscribed in the same position. That is, the circumference C1 of the ratchet gear 322 is included in the circumference C2 of the rack portion 564 of the winding operation lever 500, and the circumference C2 contacts the inside of the circumference C1 (the side where the center O1 exists) whose radius is larger than the radius of the circumference C2. By bringing the position of the rotation center O1 of the ratchet gear 322 and the position of the rotation center O2 of the pivoting protruding pin 544 closer together, and by bringing the size of the radius of gyration R1 of the ratchet gear 322 and the size of the radius of gyration R2 of the protruding pin 544 for pivoting closer together, it is possible to increase the proximity area CR where the circumference C1 of the ratchet gear 322 and the circumference C2 of the winding operation lever 500 approach each other.

Specifically, the radius of gyration R2 of the pivoting protruding pin 544 is preferably larger than twice (diameter) the radius of gyration R1 of the ratchet gear 322 and less than three times the radius of gyration R1 of the ratchet gear 322 (2×R1<R2≤3×R1). By satisfying this relationship, the circumference C1 of the ratchet gear 322 and the circumference C2 of the winding operation lever 500 can be brought closer to each other to expand the area where the rack portion 564 engages with the ratchet gear 322.

By increasing the proximity area CR, the area where the pivoting protruding pin 544 engages with the ratchet gear 322 can be expanded. The distance at which the force is transmitted from the pivoting protruding pin 544 to the ratchet gear 322 can be increased, and the movement length of the cleaning material CT can be increased. In addition, the precise engagement allows the force from the pivoting protruding pin 544 to be fully transmitted to the ratchet gear 322.

When the circumference C1 of the ratchet gear 322 and the circumference C2 of the rack portion 564 of the winding operation lever 500 are in a position where they are in contact with each other, the circumference C1 of the ratchet gear 322 and the circumference C2 of the rack portion 564 of the winding operation lever 500 will face each other and contact each other on the outside. Therefore, the area where the pivoting protruding pin 544 engages with the ratchet gear 322 must be narrowed, and it becomes difficult to sufficiently transmit the force from the protruding pin for pivoting 544 to the ratchet gear 322.

<<<Modification>>>

The above-described example is a configuration in which the cleaning material CT wound on the rotatable supply reel 200 is guided to the cleaning head portion 412, and the used portion of the cleaning material CT is wound on the rotatable winding reel 300. In addition to being held in a wound up state, the cleaning material CT may be folded or stored randomly.

<<<<<Another Embodiment>>>>>

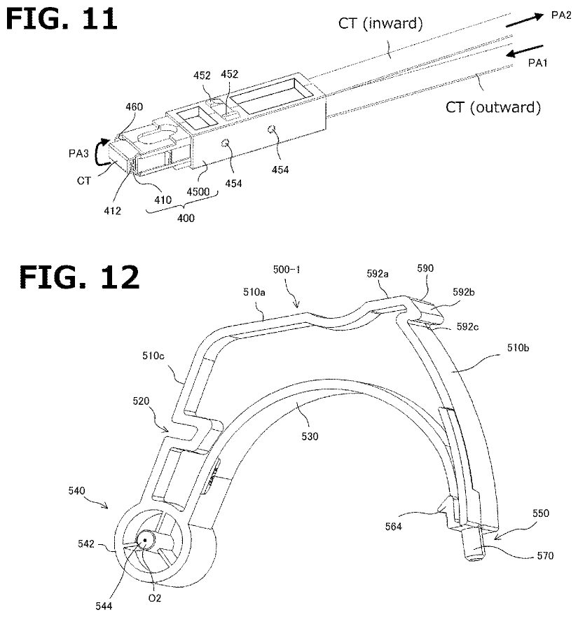

FIG. 11 is a perspective view illustrating a holding adapter 4500 according to another embodiment.

<<Opening 458>>

As illustrated in FIG. 11, the holding adapter 4500 has two openings 458 along the direction of movement of the cleaning material CT. The holding adapter 4500 has a lightened shape. The two openings 458 prevent the cleaning material CT from coming into contact with the holding adapter 4500 when it moves inside the holding adapter 4500, thereby keeping the cleaning material CT clean. In addition, by preventing contact with the holding adapter 4500, the cleaning material CT can be moved in a stable manner. The number of openings is not limited to two.

<<<<Another Embodiment of Cleaning Material CT>>>>

Next, a cleaning material CT particularly suitable as a constituent member of the optical connector cleaning tool of the present invention will be described in detail. Matters that have already been explained about the cleaning material CT may be omitted here. The matters described here can be applied to all embodiments of the invention to the extent that no contradictions arise.

The following is a case where the resin layer forming the cleaning material CT is a polyurethane resin.

<<<Physical Properties>>>

The physical properties of the cleaning material CT are described below. When evaluating the cleaning performance evaluation (pin transfer, trash removal, and fiber portion transfer) of a cleaning material including a resin layer and a base material, the evaluation shall be performed with the resin layer and the base material included. When evaluating the physical properties (tensile strength, tear strength, elongation, elongation rate, hysteresis loss, and hardness) of a cleaning material including a resin layer and a base material, evaluation and measurement are performed on the resin layer alone (single layer) separated from the base material.

<<Asker C Hardness>>

The Asker C hardness of the resin layer of the cleaning material CT is preferably from 40 to 90, and more preferably from 65 to 85. When the Asker C hardness of the resin layer of the cleaning material CT is in such a range, it can follow the shape of the surface to be cleaned, and the collection performance of contaminants becomes high. In particular, when used for the connecting end face of an optical connector for optical fibers with protruding guide pins, it can follow the shape of the guide pins, and has a remarkably high cleaning effect on the guide pins and the connecting end face of the optical connector.

The Asker C hardness of the resin layer of the cleaning material CT is measured by the method described in JIS K7312:1996, “Physical testing methods for molded products of thermosetting polyurethane elastomers”. The measurement is performed using an Asker durometer type C. In the measurement, the resin layer of the cleaning material CT shall be used after the curing of the polyurethane resin is completed and stored for 24 hours at 25° C. and 50% RH.

<<Tensile Properties Such as Tensile Strength>>

The tensile strength of the resin layer of the cleaning material CT is preferably from 0.55 to 30 MPa, more preferably from 0.6 to 30 MPa, and particularly preferably from 0.65 to 22 MPa.

When the tensile strength of the resin layer of the cleaning material CT is in such a range, it can follow the shape of the surface to be cleaned and has a high contaminant collection performance. In particular, when used for the connecting end face of an optical connector for optical fibers with protruding guide pins, it can follow the shape of the guide pins, and has a remarkably high cleaning effect on the guide pins and the connecting end face of the optical connector.

The elongation at break of the resin layer of the cleaning material CT is preferably from 100 to 150 mm, and more preferably from 105 to 140 mm. When the elongation at break of the resin layer of the cleaning material CT is in such a range, it can follow the shape of the surface to be cleaned and has a high contaminant collection performance. In particular, when used for the connecting end face of an optical connector for optical fibers with protruding guide pins, it can follow the shape of the guide pins, and has a remarkably high cleaning effect on the guide pins and the connecting end face of the optical connector.

The elongation rate at break of the resin layer of the cleaning material CT is preferably from 200 to 700%, and more preferably from 400 to 650%. When the elongation rate at break of the resin layer of the cleaning material CT is in such a range, it can follow the shape of the surface to be cleaned and has a high contaminant collection performance. In particular, when used for the connecting end face of an optical connector for optical fibers with protruding guide pins, it can follow the shape of the guide pins, and has a remarkably high cleaning effect on the guide pins and the connecting end face of the optical connector.

The tensile strength of the resin layer of the cleaning material CT is measured using a dumbbell specimen by the method described in JIS K7312:1996, “Rubber, vulcanized or thermoplastic—Determination of tensile stress-strain properties”. The dumbbell specimen shape is a dumbbell-shaped No. 3 specimen. The measurement is performed using a material testing machine. The crosshead speed of the material testing machine shall be 100 mm/min. Tensile strength, elongation at break, and elongation rate at break can be measured simultaneously.

<<Tear Strength>>

The tear strength of the resin layer of the cleaning material CT is preferably from 3N to 30N, and more preferably from 5N to 16N. When the tear strength of the resin layer of the cleaning material CT is in such a range, it can follow the shape of the surface to be cleaned and has a high contaminant collection performance. In particular, when used for the connecting end face of an optical connector for optical fibers with protruding guide pins, it can follow the shape of the guide pins, and has a remarkably high cleaning effect on the guide pins and the connecting end face of the optical connector.

The tear strength of the resin layer of the cleaning material CT is measured by a measurement method using an angle type specimen described in JIS K 7312: 1996 “Rubber, vulcanized or thermoplastic-Determination of tear strength”. The measurement is performed using a material testing machine. The crosshead speed of the material testing machine shall be 100 mm/min.

<<Hysteresis Loss>>

The hysteresis loss of the resin layer of the cleaning material CT is preferably from 3 to 60%, and more preferably from 5 to 50%. When the hysteresis loss of the resin layer of the cleaning material CT is in such a range, it can follow the shape of the surface to be cleaned and has a high contaminant collection performance. In particular, when used for the connecting end face of an optical connector for optical fibers with protruding guide pins, it can follow the shape of the guide pins, and has a remarkably high cleaning effect on the guide pins and the connecting end face of the optical connector.

The hysteresis loss of the cleaning material CT is measured by the method described in JIS K 7312: 1996 “Physical testing methods for molded products of thermosetting polyurethane elastomers”. The measurement is performed by a tensile hysteresis test using a material testing machine. The specimen shape is a dumbbell-shaped No. 3 specimen. The crosshead speed of the material testing machine is set at 1000 mm/min, and the hysteresis loss is measured after 30 cycles of repeated tension and compression.

When the resin layer of the cleaning material CT has these properties, the cleaning material CT can follow the shape of the surface to be cleaned, and especially when used for the connecting end face of an optical connector for optical fibers with protruding guide pins, the cleaning material CT can follow the shape of the guide pins, and has a remarkably high cleaning effect on the guide pins and the end face connecting with an optical connector. In addition, the contaminants once collected by the cleaning material CT do not adhere to the surface to be cleaned again, which significantly improves the cleaning effect.

<<<Material of Resin Layer>>>

<<Polyurethane Resin>>

The polyurethane resin is formed of a polyurethane resin composition including a polyol and a polyisocyanate, and the composition may contain other component.

<Polyol>

The number of hydroxyl groups (hereinafter referred to as the number of functional groups) contained in the structure of one molecule of polyol is preferably from 2 to 5, and more preferably from 2 to 3. When the number of hydroxyl groups in the polyol is within this range, a polyurethane resin product with good elongation, resistance to rupture, and high shape following properties can be obtained. When a plurality kinds of polyol are included in the composition, the number of hydroxyl groups in the polyols can be calculated by multiplying the percentage of each polyol by the number of hydroxyl groups in each polyol, and then adding these values.

The number average molecular weight of the polyol is preferably from 100 to 6000. When the number average molecular weight of the polyol is in such a range, a polyurethane resin product with good elongation, resistance to breakage, and high shape following properties can be obtained.

Specific examples of the polyol include, but are not limited to, polyester polyols, polycarbonate polyols, polyether polyols, polyester ether polyols, polydiene polyols, hydrogenated polydiene polyols, and polymer polyols thereof. The polyol may be used alone or in combination of two or more.

Examples of the polyester polyol include polyester polyols obtained by dehydrative condensation reactions of polyols and polycarboxylic acids, and polyester polyols obtained by ring-opening polymerization of lactone monomers such as ε-caprolactone and methylvalerolactone.

The polyol forming the polyester polyol is not particularly limited. Examples of the polyol include aliphatic polyols such as ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, 1,4-tetracosanediol, 1,6-tetracosanediol, 1,4-hexacosanediol, 1,6-octacosanediol glycerin, trimethylolpropane, trimethylol ethane, hexantriol, pentaerythritol, sorbitol, mannitol, sorbitol, mannitol, sorbitan, diglycerin, and dipentaerythritol; alicyclic polyols such as 1,2-cyclohexanediol, 1,4-cyclohexanediol, cyclohexanedimethanol, tricyclodecanedimethanol, cyclopentadiene dimethanol, 2,5-norbornanediol, 1,3-adamantanediol, and dimer diol; and aromatic polyols such as bisphenol A, bisphenol F, phenol novolac, and cresol novolac. These compounds may be used alone or in combination of two or more thereof.

The polycarboxylic acids forming polyester polyols are not limited to those that have multiple carboxyl groups in their molecular structure. Examples of the polycarboxylic acid include aliphatic polycarboxylic acids such as succinic acid, adipic acid, sebacic acid, and azelaic acid; aromatic polycarboxylic acids such as phthalic acid, terephthalic acid, isophthalic acid, and naphthalenedicarboxylic acid; alicyclic polycarboxylic acids such as hexahydrophthalic acid, hexahydroterephthalic acid, and hexahydroisophthalic acid; and acid esters thereof. These compounds may be used alone or in combination of two or more of them.

Examples of the polycarbonate polyol include those obtained by reacting a polyhydric alcohol such as ethylene glycol, 1,2-propylene glycol, 1,3-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, or diethylene glycol with diethylene carbonate, dimethyl carbonate, or diethyl carbonate.

Examples of the polyether polyol include polyethylene glycol, polypropylene glycol, and polytetramethylene ether glycol obtained by polymerization of cyclic ethers such as ethylene oxide, propylene oxide, and tetrahydrofuran, and copolyethers thereof. Polyether polyols can also be obtained by polymerizing the above cyclic ethers with polyhydric alcohols such as glycerin and trimethylol ethane.

Examples of the polyester ether polyol include those obtained by dehydrative condensation reactions between polycarboxylic acids and glycols such as diethylene glycol or propylene oxide adducts.

Examples of the polycarboxylic acid forming polyester ether polyol include aliphatic polycarboxylic acids such as succinic acid, adipic acid, sebacic acid, and azelaic acid; aromatic polycarboxylic acids such as phthalic acid, terephthalic acid, isophthalic acid, and naphthalic dicarboxylic acid; alicyclic polycarboxylic acids such as hexahydrophthalic acid, hexahydroterephthalic acid, and hexahydroisophthalic acid; and acid esters thereof. These compounds may be used alone or in combination of two or more of them.

Polymer polyols are obtained by the polymerization of ethylenically unsaturated monomers in polyols.

Examples of the ethylenically unsaturated monomers include

acrylic monomers, such as alkyl (meth)acrylates such as (meth)acrylonitrile and methyl methacrylate (the alkyl moiety may have 1 to 20 carbons, or more);

hydrocarbon monomers, such as aromatic unsaturated hydrocarbons such as styrene, aliphatic unsaturated hydrocarbons such as alpha-olefins and butadiene (for example, alkenes and alkadiene with 2 to 20 carbons or more);

and a combination of two or more of these [for example, a combination of acrylonitrile/styrene (from 100/0 to 80/20 by weight)].

Of these polyols, it is preferable to include a polyether polyol, polyester polyol, or a polymer polyol, and it is more preferable to include two or more of these polyols. When these polyols are used, the resulting polyurethane resin material has good elongation, is difficult to break, and has high shape following properties.

<Polyisocyanate>

The polyisocyanate is not specifically limited, and may be a bifunctional polyisocyanate or a tri- or more functional polyisocyanate.

Examples of the bifunctional polyisocyanate include aromatic polyisocyanates such as 2,4-toluene diisocyanate (2,4-TDI), 2,6-toluene diisocyanate (2,6-TDI), m-phenylene diisocyanate, p-phenylene diisocyanate, 4,4′-diphenylmethane diisocyanate (4,4′-MDI), 2,4′-diphenylmethane dianate (2,4′-MDI), 2,2′-diphenylmethane diisocyanate (2,2′-MDI), hydrogenated MDI, monomeric diphenylmethane diisocyanate (monomeric MDI), xylene diisocyanate, 3,3′-dimethyl-4,4′-biphenyl diisonate, 3,3′-dimethoxy-4,4′-biphenyl diisocyanate, polymethylene polyphenylpolyisocyanate, 1,5-naphthalene diisocyanate, xylene diisocyanate (XDI), hydrogenated XDI, and tetramethyl xylene diisocyanate (TMXDI); alicyclic polyisocyanates such as cyclohexane-1,4-diisocyanate, isophorone diisocyanate, dicyclohexylmethane-4,4′-diisocyanate, and methylcyclohexane diisocyanate; and alkylene polyisocyanates such as butane-1,4-diisocyanate, hexamethylene diisocyanate, isopropylene diisocyanate, methylene diisocyanate, and lysine diisocyanate.

Examples of the tri- or more functional polyisocyanates include 1-methylbenzole-2,4,6-triisocyanate, 1,3,5-trimethylbenzole-2,4,6-triisocyanate, biphenyl-2,4,4′-triisocyanate, diphenylmethane-2,4,4′-triisocyanate, methyl diphenyl methane-4,6,4′-triisocyanate, 4,4′-dimethyldiphenyl methane-2,2′,5,5′-tetraisocyanate, triphenyl methane-4,4′,4″-triisocyanate, polymeric MDI, lysine ester triisocyanate, 1,3,6-hexamethylene triisocyanate, 1,6,11-undecan triisocyanate, bicycloheptane triisocyanate, and 1,8-diisocyanatomethyl octane.

The polyisocyanate may be a modified form or derivative of these polyisocyanates. The isocyanates may be used alone or in combination of two or more of them.

The polyisocyanate preferably includes aromatic and aliphatic ones, and more preferably includes an aromatic one. The polyisocyanate particularly preferably includes 4,4′-diphenylmethane diisocyanate (4,4′-MDI), 2,4′-diphenylmethane dianate (2,4′-MDI), 2,2′-diphenylmethane diisocyanate (2,2′-MDI), hydrogenated MDI, monomeric diphenylmethane diisocyanate (monomeric MDI), and hexamethylene diisocyanate.

The NCO % of the polyisocyanate is preferably from 10 to 70, more preferably from 20 to 60, and particularly preferably from 30 to 55.

When the NCO % of the polyisocyanate is in such a range, a polyurethane resin product with good elongation, resistance to breakage, and high shape following properties can be obtained.

A polyurethane resin composition including these components can be molded into a sheet or other form, and then cured by light or heat to produce a resin layer.

<<<<Another Embodiment of Cleaning Tool 10>>>>

Next, particularly suitable constituent members of the optical connector cleaning tool of the present invention will be described in detail. The matters described here can be applied to all embodiments of the invention to the extent that no contradictions arise.

Members that can come into contact with the cleaning material CT (for example, the cleaning material guide 180, the cleaning head holder 410, and the holding adapter 450, etc.) preferably contain a filler. Some members may contain a filler, or all members may contain a filler. Each member may be formed so that only a part of the region contains the filler, or the entire member may be formed so as to contain the filler.

When a member that can come into contact with the cleaning material CT contains a filler, the part of the member that can come into contact with the cleaning material CT (the surface that can come into contact with the cleaning material CT) forms unevenness by the filler appearing, or unevenness along the filler embedded in the thick part of the member. This unevenness prevents the cleaning material CT from sticking to the members, and allows the cleaning material CT to be rolled out smoothly.

The method of including such fillers in each member is not particularly limited and includes the following methods: (1) kneading a filler in advance when producing the member, (2) burying a filler on the member surface while reducing the viscosity of the member surface by heat or solvent, and (3) applying an adhesive or resin material containing a filler to the member surface.

The material of the filler is not particularly limited, and may be a resin filler or an inorganic filler. When a filler that tends to be relatively positively charged is introduced where the material for forming the member tends to be negatively charged, the member is prevented from being charged, adhesion between the cleaning material CT and the member is prevented, and the cleaning material CT can be smoothly unrolled. From this viewpoint, the filler is preferably a POM filler, a PP filler, a PET filler, an acrylic resin filler, or a glass filler, and more preferably a glass filler. The filler may be used alone or in combination of two or more.

The particle size of the filler is not particularly limited, and may be, for example, from 0.1 to 1000 μm, preferably from 1 to 100 μm.

The member that can come into contact with the cleaning material CT may be roughened at the point where it can come into contact with the cleaning material CT, or it may be made uneven by the constituent member itself. This prevents the cleaning material CT from adhering to the member, and allows the cleaning material CT to be smoothly delivered.

<<<<Scope of Embodiments>>>>

As described above, the present invention has been described by means of the present embodiments, but the description and drawings that form part of this disclosure should not be understood as limiting the present invention. As such, the present invention will of course include various embodiments and the like not described herein.

In particular, the predetermined cleaning tool described by the present embodiment includes both an embodiment in which the used cleaning material CT is replaceable and an embodiment in which the used cleaning material CT is not replaceable (disposable form). In the form in which the used cleaning material CT is replaceable, a known method of replacing the cleaning material CT may be adopted. For example, the used cleaning material CT may be replaced for each supply reel and/or winding reel.

According to this point of view, it is also possible to interpret the present invention as a predetermined cleaning material CT suitable for use in a predetermined optical connector cleaning tool with a predetermined mechanism. In particular, when the cleaning material CT is replaceable in a certain optical connector cleaning tool with a certain mechanism, the cleaning material CT for replacement can also be understood to be included in the present invention.

According to another point of view, the present invention can also be a given optical connector cleaning tool suitable for use with a given cleaning material CT.

### Examples

Next, specific examples of the cleaning material CT, which is preferably used as a constituent material of the cleaning tool 10 of the present invention, will be described in detail by means of examples and reference examples. The present invention is not limited to these examples.

<<<<Production of Cleaning Material CT>>>>

Cleaning materials CT for Examples 1 to 8 and Reference Examples 1 to 3 were obtained in the following manner.

### Example 1

A mixture of 10 mass % of an ester-based diol with an average molecular weight of 1500, 80 mass % of an ether-based diol with an average molecular weight of 2000, and 10 mass % of an ether-based triol with an average molecular weight of 1500 was prepared and used as the main agent.

A mixture of monomeric diphenylmethane diisocyanate carbodiimide-modified isocyanate, an ether-based triol with an average molecular weight of 3000, and an ester-based diol with an average molecular weight of 500 was reacted at 80° C. for 2 hours to produce a prepolymer containing about 18.9% NCO as a hardener.

The hardener was transferred to a container, the main agent was weighed so that the equivalent ratio of the hydroxyl groups of the polyol in the main agent to the isocyanate groups of the polyisocyanate in the hardener was 1.2 (equivalent amount of isocyanate groups/equivalent amount of hydroxyl groups), and the main agent was dropped into the hardener with stirring.

After completion of the drop, a catalyst (0.3 g of dibutyltin dilaurate) was added, and the mixture was thoroughly mixed and then defoamed under vacuum to obtain a mixed liquid according to Example 1.

<<Cleaning Material CT for Cleaning Performance Evaluation>>

Next, the cleaning material CT for cleaning performance evaluation was produced as follows.

The obtained mixed liquid was poured onto the non-release surface of a mold-release treated PET film (Cerapeel BKE-RX, Toray Advanced Film Co., Ltd.) with a thickness of 25 μm, and made into a film-shaped material with a thickness of 350 μm using an applicator (Film Applicator No. 350FA, Coating Tester K.K.).

The film-shaped material was heated in a drying oven at 100° C. for 60 minutes to cause a urethanization reaction and complete curing.

The cleaning material CT, a sheet-shaped material with a thickness of 350 μm, was obtained in the above manner. The PET film was used as is as the base material of the cleaning material CT.

<<Cleaning Material CT for Evaluation of Resin Layer Properties (Sample for Physical Property Evaluation)>>

The cleaning material CT (sample for property evaluation) for property evaluation of the resin layer was produced as follows.

The obtained mixed liquid was poured onto the release surface of a mold-release treated PET film (Cerapeel BKE-RX, Toray Advanced Film Co., Ltd.) with a thickness of 25 μm, and made into a film-shaped material with a thickness of 350 μm using an applicator (Film Applicator No. 350FA, Coating Tester K.K.).

The film-shaped material was heated in a drying oven at 100° C. for 60 minutes to cause a urethanization reaction and complete curing.

### Examples 2 to 8 and Reference Examples 1 to 3

The resin layer of the cleaning material CT and the cleaning material CT for Examples 2 to 8 and Reference Examples 1 to 3 were obtained in the same manner as in Example 1 under the various conditions described in Tables 1 and 2.

The combination of the main agent and hardener used in each example and reference example is as follows.

TABLE 1

| | | |
|---|---|---|
| Example 1 | Main | A mixture prepared by blending a mixture of 10 mass % of an ester-based diol with a molecular weight of about 1500 |
| | agent | and 80 mass % of an ether-based diol with a molecular weight of 2000 with 10 mass % of an ether-based triol with |
| | | a molecular weight of about 1500 |
| | Hardener | A prepolymer with an NCO content of about 12 mass % made by reacting hexamethylene diisocyanate with an ester- or |
| | | ether-based triol mixture with a molecular weight of 500 to 6000 and an ester- or ether-based diol mixture |
| | | with a molecular weight of 100 to 6000 at 80° C. for 2 hours |
| Example 2 | Main | A mixture prepared by blending a mixture of 10 mass % of an ester-based diol and 70 mass % of an ether-based diol |
| | agent | with a molecular weight of about 800 to 2000 with 20 mass % of an ether-based triol with a molecular weight |
| | | of about 1000 to 2000 |
| | Hardener | A prepolymer with an NCO content of about 18.9 mass % made by reacting monomeric diphenylmethane diisocyanate |
| | | carbodiimide-modified isocyanate with an ester- or ether-based triol mixture with a molecular weight of 3000 to 6000 |
| | | and an ester- or ether-based diol mixture with a molecular weight of 500 to 3000 at 80° C. for 2 hours |
| Example 3 | Main | A mixture prepared by blending a mixture of 10 mass % of an ester-based diol with a molecular weight of about 1500 |
| | agent | and 80 mass % of an ether-based diol with a molecular weight of about 3000 with 10 mass % of an ether-based |
| | | triol with a molecular weight of about 1500 |
| | Hardener | A prepolymer with an NCO content of about 18.9 mass % made by reacting monomeric diphenylmethane diisocyanate |
| | | carbodiimide-modified isocyanate with an ester- or ether-based triol mixture with a molecular weight of 3000 to 6000 |
| | | and an ester- or ether-based diol mixture with a molecular weight of 500 to 3000 at 80° C. for 2 hours |
| Example 4 | Main | A mixture prepared by blending a mixture of 10 mass % of an ester-based diol with a molecular weight of about 1500 |
| | agent | and 80 mass % of an ether-based diol with a molecular weight of about 3000 with 10 mass % of an ether-based |
| | | triol with a molecular weight of about 1500 |
| | Hardener | A prepolymer with an NCO content of about 30 mass % made by reacting monomeric diphenylmethane diisocyanate |
| | | carbodiimide-modified isocyanate with an ester- or ether-based triol mixture with a molecular weight of 3000 to |
| | | 6000 and an ester- or ether-based diol mixture with a molecular weight of 500 to 3000 at 80° C. for 2 hours |
| Example 5 | Main | A mixture prepared by blending a mixture of 10 mass % of an ester-based diol with a molecular weight of about 1500 |
| | agent | and 80 mass % of an ether-based diol with a molecular weight of 2000 with 10 mass % of an ether-based triol with |
| | | a molecular weight of about 1500 |
| | Hardener | A prepolymer with an NCO content of about 18.9 mass % made by reacting monomeric diphenylmethane diisocyanate |
| | | carbodiimide-modified isocyanate with an ester- or ether-based triol mixture with a molecular weight of 3000 to 6000 |
| | | and an ester- or ether-based diol mixture with a molecular weight of 500 to 3000 at 80° C. for 2 hours |
| Example 6 | Main | A mixture prepared by blending a mixture of 10 mass % of an ester-based diol and 70 mass % of an ether-based diol |
| | agent | with a molecular weight of about 800 to 2000 with 20 mass % of an ether-based triol with a molecular weight |
| | | of about 1000 to 2000 |
| | Hardener | A prepolymer with an NCO content of about 12 mass % made by reacting hexamethylene diisocyanate with an ester- or |
| | | ether-based triol mixture with a molecular weight of 500 to 6000 and an ester- or ether-based diol mixture |
| | | with a molecular weight of 100 to 6000 at 80° C. for 2 hours |
| Example 7 | Main | A mixture prepared by blending a mixture of 10 mass % of an ester-based diol and 80 mass % of an ether-based diol |
| | agent | with a molecular weight of 200 to 800 with 5 mass % of an ester-based triol and 5 mass % of an ether-based triol |
| | | with a molecular weight of 200 to 800 |
| | Hardener | A prepolymer with an NCO content of about 18.9 mass % made by reacting monomeric diphenylmethane diisocyanate |
| | | carbodiimide-modified isocyanate with an ester- or ether-based triol mixture with a molecular weight of 3000 to 6000 |
| | | and an ester- or ether-based diol mixture with a molecular weight of 500 to 3000 at 80° C. for 2 hours |
| Example 8 | Main | A mixture prepared by blending a mixture of 10 mass % of an ester-based diol and 70 mass % of an ether-based diol |
| | agent | with a molecular weight of 200 to 800 with 15 mass % of an ester-based triol and 5 mass % of an ether-based triol |
| | | with a molecular weight of 200 to 800 |
| | Hardener | A prepolymer with an NCO content of about 18.9 mass % made by reacting monomeric diphenylmethane diisocyanate |
| | | carbodiimide-modified isocyanate with an ester- or ether-based triol mixture with a molecular weight of 3000 to 6000 |
| | | and an ester- or ether-based diol mixture with a molecular weight of 500 to 3000 at 80° C. for 2 hours |
| Reference | Main | A mixture prepared by blending a mixture of about 40 mass % of an ether-based diol and 10 mass % of a triol with |
| Example 1 | agent | a molecular weight of about 6000 with a mixture of about 40 mass % of an ether-based diol polymer polyol |
| | | and about 10 mass % of triol polymer polyol with a molecular weight of about 6000 |
| | Hardener | A prepolymer with an NCO content of about 12 mass % made by reacting hexamethylene diisocyanate with an ester- or |
| | | ether-based triol mixture with a molecular weight of 500 to 6000 and an ester- or ether-based diol mixture |
| | | with a molecular weight of 100 to 6000 at 80° C. for 2 hours |
| Reference | Main | A mixture prepared by blending a mixture of about 45 mass % of an ether-based diol and about 5 mass % of an ester- |
| Example 2 | agent | based triol with a molecular weight of about 2000 with a mixture of about 45 mass % of an ether-based diol |
| | | and about 5 mass % of ester-based triol with a molecular weight of about 3000 |
| | Hardener | A prepolymer with an NCO content of about 8.8 mass % made by reacting monomeric diphenylmethane |
| | | diisocyanate with an ester- or ether-based triol mixture with a molecular weight of 3000 to 5000 and an ester- or |
| | | ether-based diol mixture with a molecular weight of 200 to 3000 at 80° C. for 2 hours |
| Reference | Main | A mixture prepared by blending a mixture of about 40 mass % of an ether-based diol and 10 mass % of a triol with |
| Example 3 | agent | molecular weight of about 6000 with a mixture of about 40 mass % of an ether-based diol polymer polyol |
| | | and about 10 mass % of triol polymer polyol with a molecular weight of about 6000 |
| | Hardener | A prepolymer with an NCO content of about 8.8 mass % made by reacting monomeric diphenylmethane |
| | | diisocyanate with an ester- or ether-based triol mixture with a molecular weight of 3000 to 5000 and an ester- or |
| | | ether-based diol mixture with a molecular weight of 200 to 3000 at 80° C. for 2 hours |

<<<<Evaluation>>>>

The following evaluation tests were conducted on the obtained cleaning material CT of each example and reference example. The evaluation results are shown in Table 2.

<<<Evaluation of Physical Properties of Resin Layer>>>

<<Asker C Hardness>>

Asker C hardness was measured according to the method described in JIS K7312:1996, “Physical testing methods for molded products of thermosetting polyurethane elastomers”.

(Preparation of Specimen)

The measurement samples were prepared by placing each mixed liquid in an aluminum cup container, adjusted to obtain a 10 mm thick resin layer, cured at 100° C. for 60 minutes, and then stored at 25° C. and 50% RH for 24 hours.

(Measurement Conditions)

The measurements were performed using an Asker rubber hardness tester type C manufactured by Kobunshi Keiki Co., Ltd.

<<Tensile Properties Such as Tensile Strength>>

<Tensile Strength, Elongation at Break, and Elongation Rate at Break>

Tensile strength, elongation at break, and elongation rate at break were measured according to the measurement method using dumbbell specimens described in JIS K7312:1996, “Physical testing methods for molded products of thermosetting polyurethane elastomers”.

(Preparation of Specimen)

The resin layer of each cleaning material CT (sheet with a thickness of 350 μm) was molded into the shape of a dumbbell-shaped No. 3 specimen to produce a dumbbell specimen.

(Measurement Conditions)

For the measurement, the resin layer was peeled off and separated from the base material using a material testing machine AGS-X (load cell: 5 kN) manufactured by Shimadzu Corporation, and the measurement was performed on a single resin layer.

The crosshead speed of the material testing machine was set at 100 mm/min, and the tensile strength, elongation at break, and elongation rate at break were measured from the load and the displacement of the crosshead when the sample broke.

<Tear Strength>

Tear strength was measured according to the measurement method using an angle-shaped specimen described in JIS K7312:1996, “Physical testing methods for molded products of thermosetting polyurethane elastomers”.

(Preparation of Specimen)

The resin layer of each cleaning material CT (sheet with a thickness of 350 μm) was molded into an angle-shaped specimen shape to produce an angle-shaped specimen.

(Measurement Conditions)

For the measurement, the resin layer was peeled off and separated from the base material using a material testing machine AGS-X (load cell: 5 kN) manufactured by Shimadzu Corporation, and the measurement was performed on a single resin layer.

The crosshead speed of the material testing machine was set at 100 mm/min for the measurement.

<<Hysteresis Loss>>

Hysteresis loss was measured according to the measurement method using an angle-shaped specimen described in JIS K7312:1996, “Physical testing methods for molded products of thermosetting polyurethane elastomers”.

(Preparation of Specimen)

The resin layer of each cleaning material CT (sheet with a thickness of 350 μm) was molded into the shape of a dumbbell-shaped No. 3 specimen to produce a dumbbell specimen.

(Measurement Conditions)

For the measurement, the resin layer was peeled off and separated from the base material using a material testing machine AGS-X (load cell: 5 kN) manufactured by Shimadzu Corporation, and the measurement was performed on a single resin layer.

The hysteresis loss was measured after 30 cycles of repetition of tension and compression with the crosshead speed of the material testing machine at 1000 mm/min. The displacement and load of the crosshead were measured from the load and displacement curves after the cycle test.

<<<Cleaning Performance Evaluation>>>

<<Evaluation of Trash Transfer from Pins and Trash Removal>>

trash transfer from pins and trash removal were evaluated using the following methods.

For the evaluation, MPO Jumper Cords manufactured by Senko Sangyo Co., Ltd. with 12 MPO at both ends, OM3 cord type, total length 1 m, flat polished or APC 8 degree polished, male to female, were used as connectors for evaluation after paper dust or AC dust FINE was adhered to the connection surface in advance.

After the connecting end face of the connector was brought into contact with the surface of each cleaning material CT, the guide pins and surface of the connecting end face of the connector were observed to check for contamination of the pins by trash transfer and for trash removal from the connecting end face of the connector.

The observation was performed at an arbitrary magnification with a microscope (model: VHX-500 F) manufactured by Keyence Corporation. It was also measured using Manta+manufactured by Sumix.

The trash transfer from pins and trash removal were judged as follows.

[symbol] : trash on the guide pins and connecting end face of the connector was completely removed.

o: Some trash remained on the connecting end face, but the trash on the fiber was removed and no problem occurred in the connection itself.

x: trash was not completely removed.

<<Evaluation of Optical Fiber Portion Transferability>>

The obtained contaminant collectors of each example and reference case were evaluated for fiber portion transferability using the following method.

For the evaluation, MPO Jumper Cords manufactured by Senko Sangyo Co., Ltd. with 12 MPO at both ends, OM3 cord type, total length 1 m, flat polished or APC 8 degree polished, male to female, were used as connectors for evaluation after paper dust or AC dust FINE was adhered to the connection surface in advance.

After the connecting end face of the connector (including the optical fiber portion) was brought into contact with the surface of each contaminant collector, the surface of the optical fiber portion of the connecting end face of the connector was observed to check for the presence of foreign matter and transfer products.

The optical fibers of the connector was observed using Manta+ manufactured by Sumix.

The transfer from the optical fiber portion was determined as follows.

[symbol] : trash on the optical fiber portion was completely removed.

o: Some trash remained on the connecting end face, but the trash on the fiber was removed and no problem occurred in the connection itself.

x: trash was not completely removed.

TABLE 2

| No | | Example 1 | Example 2 | Example 3 | Example 4 | Example 5 | Example 6 |
|---|---|---|---|---|---|---|---|
| Main agent (part by mass) | | 102 | 100 | 100 | 100 | 102 | 102 |
| Hardener (part by mass) | | 25 | 100 | 30 | 30 | 25 | 25 |
| Hardening temperature | | 100° C. | 100° C. | 100° C. | 100° C. | 100° C. | 100° C. |
| Coating thickness | | 350 μm | 350 μm | 350 μm | 350 μm | 350 μm | 350 μm |
| Cleaning | Coated base material surface | Non-release | ← | ← | ← | ← | ← |
| performance | | surface | | | | | |
| evaluation | Transfer from pins | ⊚ | ⊚ | ⊚ | ⊚ | ⊚ | ⊚ |
| | Trash removal | ◯ | ⊚ | ⊚ | ⊚ | ⊚ | ⊚ |
| | Transfer from fibers | ⊚ | ◯ | ⊚ | ⊚ | ⊚ | ⊚ |
| | Judgement | ◯ | ◯ | ⊚ | ⊚ | ⊚ | ⊚ |
| Physical | Coated base material surface | Release | ← | ← | ← | ← | ← |
| property | | surface | | | | | |
| evaluation | Tensile strength (MPa) | 0.6 | 2.34 | 0.65 | 3.96 | 7.0 | 22.0 |
| | Tear strength (N) | 5.2 | 4.03 | 6.51 | 9.27 | 5.9 | 15.6 |
| | Elongation at break (mm) | 139.0 | 130 | 86.67 | 210.00 | 135.0 | 111.7 |
| | Elongation rate at break (%) | 648.0 | 4.03 | 6.51 | 9.27 | 637.5 | 458.3 |
| | Hysteresis loss | 26.0 | 33.0 | 31.3 | 28.2 | 5.3 | 49.9 |
| | Hardness (Asker C) | 40 | 40 | 65 | 68 | 57 | 85 |

| | | | | Reference | Reference | Reference |
|---|---|---|---|---|---|---|
| No | | Example 7 | Example 8 | Example 1 | Example 2 | Example 3 |
| Main agent (part by mass) | | 102 | 102 | 102 | 102 | 102 |
| Hardener (part by mass) | | 25 | 25 | 25 | 25 | 25 |
| Hardening temperature | | 100° C. | 100° C. | 100° C. | 100° C. | 100° C. |
| Coating thickness | | 350 μm | 350μm | 350 μm | 350 μm | 350 μm |
| Cleaning | Coated base material surface | ← | ← | ← | ← | ← |
| performance | Transfer from pins | ⊚ | ◯ | X | X | ◯ |
| evaluation | Trash removal | ⊚ | ◯ | ◯ | ◯ | X |
| | Transfer from fibers | ⊚ | ⊚ | ◯ | ◯ | ◯ |
| | Judgement | ⊚ | ◯ | X | X | X |
| Physical | Coated base material surface | ← | ← | ← | ← | ← |
| property | Tensile strength (MPa) | 20.7 | 30.0 | 0.5 | 1.6 | 35 |
| evaluation | Tear strength (N) | 13.0 | 18.8 | 1.2 | 12.8 | 22.1 |
| | Elongation at break (mm) | 105.0 | 102.0 | 45.0 | 373.3 | 94 |
| | Elongation rate at break (%) | 425.0 | 412.0 | 125.0 | 1766.7 | 195 |
| | Hysteresis loss | 49.4 | 52.4 | 2.0 | 22.3 | 53.5 |
| | Hardness (Asker C) | 85 | 90 | 35 | 38 | 95 |

In addition, when the cleaning material CT of each example was actually incorporated into the cleaning tool 10 and used, it was confirmed that it could easily collect contaminants on the end face of the optical connector without interfering with the movement of the cleaning tool.

<<<<<Another Embodiments>>>>>

<<Tenth Aspect>>

The optical connector cleaning tool according to the tenth aspect includes an operating body (for example, a winding operation lever 500-1 described below) that can be rotated by operation by an operator and has a limiting portion (for example, a recess 520 and a protrusion 590 described below) that limits the range of rotation;

a main body (for example, a storage area 160 described below) having a cleaning head to which a cleaning material for cleaning an optical connector is guided, and having a wall defining an opening (for example, an opening 170 for the winding operation lever described below) through which the operating body is operably extended, the opening having a first opening end (for example, an upper end 173 described below) and a second opening end (for example, an engaging end 174 described below) facing each other; and

a pulling body (for example, a winding reel 300 described below) that pulls the cleaning material that has passed through the cleaning head by displacement of the operating body,

in which the limiting portion has a protrusion (for example, a protrusion 590 described below) that protrudes from the opening, and

the rotation of the operating body engages the protrusion with the first opening end to lock the operating body (for example, the state in FIG. 14).

Since the protrusion engages with the first opening end to lock the operating body, the operating body can be positioned in a certain position and the amount of displacement of the cleaning material can be kept constant. Since the amount of movement of the operating body by a single operation of the operating body can be kept constant, the cleaning material can be displaced without fail.

In addition, since the amount of movement of the operating body can be kept constant, the cleaning material can always be displaced by a certain amount without depending on the skill of the operator. This prevents damage caused by unintentional application of force by the operator.

Furthermore, since it is only necessary to replace the operating body with one that has a limiting portion, there is no need to change or process the main body, and the change can be made inexpensively.

<<Eleventh Aspect>>

The eleventh aspect is the optical connector cleaning tool according to the tenth aspect, in which the limiting portion has a wall that defines a recess (for example, a recess 520 described below) at a different position from the protrusion, and

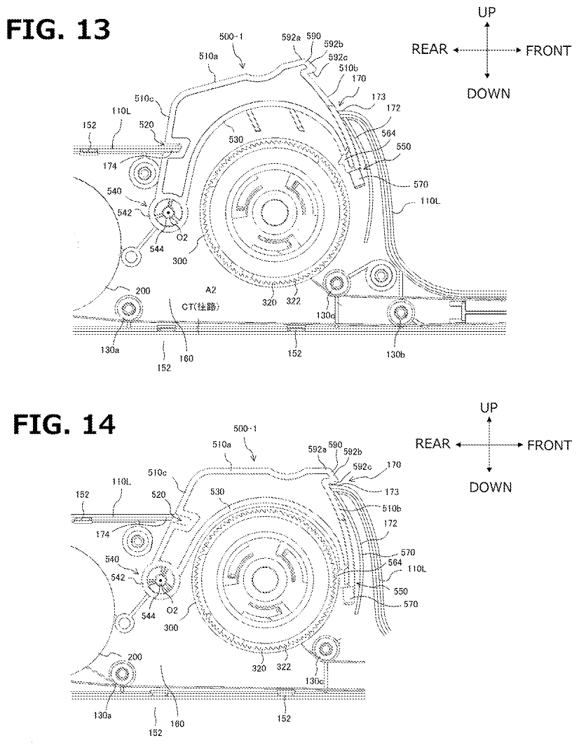

the rotation of the operating body engages the recess with the second opening end to lock the operating body (for example, the state in FIG. 13).

Since the operating body can be rotated between the state in which the recess is engaged with the second opening end and the state in which the protrusion is engaged with the first opening end, the amount of movement of the operating body can always be kept constant.

<<Twelfth Aspect>>

A twelfth aspect is the optical connector cleaning tool according to the eleventh aspect,

in which the operating body has an urging force generating portion that urges in the first direction (for example, a coil spring 580),

in which the recess engages with the second opening end when the operating body is displaced in the first direction (for example, counterclockwise in FIGS. 13 and 14), and

the protrusion engages with the first opening end when the operating body is displaced in the second direction (for example, clockwise in FIGS. 13 and 14) different from the first direction.

Since the operating body can be rotated between the state in which the recess is engaged with the second opening end and the state in which the protrusion is engaged with the first opening end, the amount of movement of the operating body can always be kept constant, and the amount of displacement of the cleaning material can be constant without depending on the skill of the operator.

FIG. 12 is a perspective view schematically illustrating a winding operation lever 500-1 according to another embodiment. FIG. 13 is a schematic view illustrating the state of the winding operation lever 500-1 when it is positioned at a first rotation angle. FIG. 14 is a schematic view illustrating the state of the winding operation lever 500-1 when it is positioned at a second rotation angle.

<<<Configuration of Winding Operation Lever 500-1>>>

As illustrated in FIGS. 12 to 14, the cleaning tool 10 according to another embodiment has a winding operation lever 500-1 instead of the winding operation lever 500 of the present embodiment. The winding operation lever 500-1 has a protrusion 590. The winding operation lever 500-1 has essentially the same configuration as the winding operation lever 500, except for the protrusion 590. The same sign is used to indicate the same components as the winding operation lever 500. The winding operation lever 500-1 has a substantially U-shaped columnar shape.

As with the winding operation lever 500, the operator who cleans the end face ES of the ferrule FE of the optical connector can move the cleaning material CT by operating the winding operation lever 500-1. The movement of the cleaning material CT guides the clean area of the cleaning material CT to the cleaning head portion 412, and presses the clean area of the cleaning material CT against the end face ES of the ferrule FE to remove dust and other soil.

<<<Protrusion 590>>>

The protrusion 590 extends from the winding operation lever opening 170 and protrudes toward the front of the cleaning tool 10. In other words, the protrusion 590 protrudes in the direction away from the pivoting protruding pin 544, which is a rotation center O2.

The protrusion 590 is located at the intersection of the outer circumference surface 510a and the outer circumference surface 510b. The protrusion 590 has an extending surface 592a, a protruding surface 592b, and a locking surface 592c.

<Extending Surface 592a>

The extending surface 592a extends forward from the outer circumference surface 510a. More specifically, the extending surface 592a extends in a direction that is flush with the outer circumference surface 510a and away from the pivoting protruding pin 544.

<Protruding Surface 592b>

The protruding surface 592b is formed in connection with the extending surface 592a. The protruding surface 592b is formed at a position where it protrudes from and is separated from the outer circumference surface 510b. The protruding surface 592b is formed substantially parallel to the outer circumference surface 510b.

<Locking Surface 592c>

The locking surface 592c connects to the protruding surface 592b and the outer circumference surface 510b. The locking surface 592c protrudes in a direction away from the outer circumference surface 510b.

<<<Movement of Winding Operation Lever 500-1>>>

The winding operation lever 500-1 can be rotated (pivoted) in the same way as the winding operation lever 500, with the pivoting protruding pin 544 as the rotation center O2.

<Upper Limit Position>

The outer circumference surface 510c of the winding operation lever 500-1 has the recess 520. As illustrated in FIG. 13, the recess 520 can be entered and contacted by the engaging end 174 of the winding operation lever opening 170. The upper limit position (first rotation angle) of the winding operation lever 500-1 can be determined by the contact of the engaging end 174 with the recess 520.

As with the winding operation lever 500, an urging force is applied to the winding operation lever 500-1 by the coil spring 580. When the operator loosens the force from the winding operation lever 500-1, the urging force of the coil spring 580 rotates the winding operation lever 500-1 counterclockwise (first direction), and the winding operation lever 500-1 returns to the upper limit position (first rotation angle). As described above, the upper limit position can be made a constant position by contacting the engaging end 174 with the recess 520, and the upper limit position can be made a standard position.

<Lower Limit Position>

As described above, the protrusion 590 is provided at the intersection of the outer circumference surface 510a and the outer circumference surface 510b of the winding operation lever 500-1. The protrusion 590 protrudes from the winding operation lever opening 170. As illustrated in FIG. 14, the locking surface 592c of the protrusion 590 can engage with an upper end 173 of the open wall 172 formed in the left housing 110L. The lower limit position (second rotation angle) of the winding operation lever 500-1 can be determined by the engagement of the protrusion 590 with the upper end 173.

When the operator applies a force to the winding operation lever 500-1 against the urging force of the coil spring 580, the force applied by the operator causes the winding operation lever 500-1 to rotate clockwise (second direction), and the winding operation lever 500-1 can move to the lower limit position. By engaging the locking surface 592c of the protrusion 590 with the upper end 173, the winding operation lever 500-1 can be positioned at the lower limit. By setting the upper end 173 to the lower limit position, the winding operation lever 500-1 can be positioned in a certain position.

<Rotation Between Upper Limit Position (First Rotation Angle) and Lower Limit Position (Second Rotation Angle)>

The recess 520 and the protrusion 590 on the winding operation lever 500-1 allow the lever to be rotated (pivoted) between the upper limit position (first rotation angle) and the lower limit position (second rotation angle) by the operator's operation of the winding operation lever 500-1. The engagement with the recess 520 and the protrusion 590 can tell the operator the degree of force to be applied, and the winding operation lever 500-1 can be rotated (pivoted) within a certain range without depending on the skill level of the operator.

As with the winding operation lever 500, a rack and pinion mechanism is configured by the largely inclined tooth surface of the rack portion 564 of the winding operation lever 500-1 and the largely inclined tooth surfaces of the ratchet gear 322 of the winding reel 300. When the winding operation lever 500-1 is pushed into the storage area 160 by the operator (see arrow A2 in FIGS. 8 and 9), a force is transmitted to the winding reel 300 by the rack and pinion mechanism, causing the winding reel 300 to rotate. As the winding reel 300 rotates, the cleaning material CT is pulled (see arrow PA1 in FIG. 9) and wound around the winding reel 300. As the cleaning material CT is pulled, the cleaning material CT is newly fed from the supply reel 200, and the clean resin layer RL of the cleaning material CT is supplied to the cleaning head portion 412 of the cleaning head holder 410 (see arrow PA3 in FIG. 7(a)).

<<<<Scope of Another Embodiment>>>>

As described above, the present invention has also been described as another embodiment, but the description and drawings that form part of this disclosure should not be understood as limiting the invention. Thus, the present invention includes various embodiments and others that are not described herein.

### REFERENCE SIGNS LIST

10 Cleaning tool
100 Housing
156 Cleaning material guide plate
160 Storage area
170 Winding operation lever opening
173 Upper end
174 Engaging end
200 Supply reel
300 Winding reel
322 Ratchet gear
410 Cleaning head holder
412 Cleaning head portion
500 Winding operation lever
500-1 Winding operation lever
520 Recess
590 Protrusion
540 First end
550 Second end
580 Coil spring
CT Cleaning material

1. An optical connector cleaning tool, comprising:
a main body in which a cleaning material for cleaning the end face of an optical connector is held;
a supply reel on which the cleaning material is wound so that it can be fed out;
a cleaning head to which the cleaning material fed from the supply reel is guided;
a winding reel that winds the cleaning material that has passed through the cleaning head;
an operating body that can be pivoted by operation by an operator; and
a rotary engaging body that engages with the operating body to transmit the movement of the operating body to rotate the winding reel;
wherein the arc caused by the pivoting of the operating body is inscribed in the arc caused by the rotation of the rotary engaging body, and the operating body and the rotary engaging body are engaged with each other.

2. The optical connector cleaning tool according to claim 1,
wherein the operating body has a first end and a second end facing the first end,
the operating body is pivotable about the first end, and
the operating body comprises a stretchable elastic body at the second end.

3. The optical connector cleaning tool according to claim 1, wherein the diameter of the outer circumference formed by the rotation of the rotary engaging body is the same as the diameter of the winding reel.

4. The optical connector cleaning tool according to claim 1, wherein the main body has an opening for operably protruding the operating body,
the operating body has a recess facing the end of the opening,
the state in which the end of the opening is contained in the recess is the standard position of the operating body, and
at least a part of the recess is covered by the end of the opening when the operating body is operated by an operator.

5. The optical connector cleaning tool according to claim 1, further comprising a guide that guides the cleaning material that is fed from the supply reel and reaches the cleaning head.

6. The optical connector cleaning tool according to claim 5, wherein the guide has at least one through hole on the surface facing the cleaning material.

7. The optical connector cleaning tool according to claim 5, wherein the guide comprises a filler.

8. The optical connector cleaning tool according to claim 1, wherein the winding reel has two reel frames that face each other with a gap between them and hold the wound cleaning material in the gap.

9. The optical connector cleaning tool according to claim 1, wherein the cleaning material has a resin layer comprising a polyurethane resin, and
the resin layer has a tensile strength of 0.6 to 30 MPa, an Asker C hardness of 40 to 90, and a hysteresis loss of 5 to 53.

10. An optical connector cleaning tool, comprising:
an operating body that can be rotated by operation by an operator and has a limiting portion that limits the range of rotation;
a main body having a cleaning head to which a cleaning material for cleaning an optical connector is guided, and having a wall defining an opening through which the operating body is operably extended, the opening having a first opening end and a second opening end facing each other; and
a pulling body that pulls the cleaning material that has passed through the cleaning head by displacement of the operating body,
wherein the limiting portion has a protrusion that protrudes from the opening, and
the rotation of the operating body engages the protrusion with the first opening end to lock the operating body.

11. The optical connector cleaning tool according to claim 10, wherein the limiting portion has a wall that defines a recess at a different position from the protrusion, and
the rotation of the operating body engages the recess with the second opening end to lock the operating body.

12. The optical connector cleaning tool according to claim 11, wherein the operating body has an urging force generating portion that urges in the first direction,
wherein the recess engages with the second opening end when the operating body is displaced in the first direction, and
the protrusion engages the first opening end when the operating body is displaced in the second direction different from the first direction.
